(19) United States
(12) Patent Application Publication
(10) Pub. No.: US 2007/0233635 A1
(43) Pub. Date: Oct. 4, 2007

(54) Systems and methods for organizing an event and tracking attendance status

(76) Inventors: Craig Burfeind, Chanhassen, MN (US); Elan Sufian Feingold, Pasadena, CA (US)

Correspondence Address: DIGITAL CYCLONE, INC.;c/o GARMIN INTERNATIONAL, INC., 1200 EAST 151ST STREET, ATTN: LEGAL - IP, OLATHE, KS, 66062, US

(21) Appl. No.: 11/397,326

(22) Filed: Apr. 4, 2006

(51) Int. Cl. G06F 17/30; G06F 7/00

(52) U.S. Cl. 707/1

(57) ABSTRACT

A user accesses an organization device and schedules a location-specific event. The user has the option of inviting event participants, who can send to the organization device a response regarding the participation status of the invitee. The organization device tracks the participation status of each invitee. The organization device can also provide the participation status of each invitee to other invitees. In some cases, the organization device can communicate with a portable, location-aware electronic device of one or more of the invitees. In such cases, the organization device can also track and provide the arrival status of these invitees.

### BACKGROUND

Planning events can be time consuming and complicated. Event information, such as location and time, must be communicated to multiple parties. Keeping track of who is planning on attending adds to the complication. As the time for the event nears, guests often call the organizer and/or each other to determine who is coming, who has arrived, and how late they are. There exists a need for better event organization systems and methods.

### SUMMARY

In general, the present disclosure describes methods and systems for organizing an event. In particular, the present disclosure describes systems and methods for organizing an event and tracking the attendance status of event participants.

According to some embodiments, a user accesses an organization device and schedules a location-specific event. The user has the option of inviting event participants.

According to one aspect, the organization device tracks the participation status of each invitee. In some embodiments, the invitees can send to the organization device a response to an event invitation regarding the participation status of the invitee.

According to another aspect, the organization device can also provide the participation status of each invitee to other invitees.

According to yet another aspect, the organization device can also track and provide the arrival status of these invitees. In some embodiments, the organization device can communicate with a portable, location-aware electronic device of one or more of the invitees to determine a current geographic location of the portable device.

### BRIEF DESCRIPTION OF THE DRAWINGS

FIG. 1 illustrates an operation flow for a process for creating an event and tracking the attendance status of event participants according to one embodiment of the present disclosure;

FIG. 2 illustrates a schematic of one exemplary embodiment of a network including multiple interconnected entities according to one embodiment of the present disclosure;

FIG. 3 illustrates a block diagram of an example network and communication environment of an organization device according to one embodiment of the present disclosure;

FIG. 4 illustrates a block diagram of an example hardware and operating environment of an organizing device according to one embodiment of the present disclosure;

FIG. 5 illustrates a block diagram of an example hardware and operating environment of a portable device according to one embodiment of the present disclosure;

FIG. 6 illustrates a block diagram of an example operating environment in which a portable device can access the Internet according to one embodiment of the present disclosure;

FIG. 7 illustrates one example of a menu interface according to one embodiment of the present disclosure;

FIG. 8 illustrates an operation flow for a process for displaying a menu interface according to one embodiment of the present disclosure;

FIG. 9 illustrates an operation flow for a process for adding a contact to an address book according to one embodiment of the present disclosure;

FIG. 10 illustrates one example of a new contact interface according to one embodiment of the present disclosure;

FIG. 11 illustrates an operation flow for a process for creating a group of contacts according to one embodiment of the present disclosure;

FIG. 12 illustrates one example of a new group interface according to one embodiment of the present disclosure;

FIG. 13 illustrates one example of an edit group interface according to one embodiment of the present disclosure;

FIG. 14 illustrates an operation flow for a process for adding a location to a locations list according to one embodiment of the present disclosure;

FIG. 15 illustrates one example of a new location interface according to one embodiment of the present disclosure;

FIG. 16 illustrates an operation flow for a process for creating an event according to one embodiment of the present disclosure;

FIG. 17 illustrates an operation flow for a process for scheduling a new event according to one embodiment of the present disclosure;

FIG. 18 illustrates one example of a create event interface according to one embodiment of the present disclosure;

FIG. 19 illustrates an operation flow for a process for receiving an event invitation according to one embodiment of the present disclosure;

FIG. 20 illustrates an operation flow for a process for receiving a response to an invitation according to one embodiment of the present disclosure;

FIG. 21 illustrates one example of an event calendar interface according to one embodiment of the present disclosure;

FIG. 22 illustrates an operation flow for a process for viewing a calendar of events according to one embodiment of the present disclosure;

FIG. 23 illustrates an operation flow for a process for editing an event according to one embodiment of the present disclosure;

FIG. 24 illustrates an operation flow for a process for canceling an event according to one embodiment of the present disclosure;

FIG. 25 illustrates an operation flow for a process for providing participation status of event invitees according to one embodiment of the present disclosure;

FIG. 26 illustrates one example of an event status interface according to one embodiment of the present disclosure;

FIG. 27 illustrates an operation flow for a process for obtaining invitee location information according to one embodiment of the present disclosure;

FIG. 28 illustrates an operation flow for a process for tracking invitee location information according to one embodiment of the present disclosure;

FIG. 29 illustrates an operation flow for a process for providing invitee arrival information according to one embodiment of the present disclosure;

FIG. 30 illustrates one example menu interface configured to display on a WAP browser of a cellular phone;

FIG. 31 illustrates one example new contact interface configured to display on the WAP browser of FIG. 30;

FIG. 32 illustrates one example new location interface configured to display on the WAP browser of FIG. 30;

FIG. 33 illustrates one example new event interface configured to display on the WAP browser of FIG. 30;

FIG. 34 illustrates one example date scheduling interface tool configured to display on the WAP browser of FIG. 30;

FIG. 35 illustrates one example event calendar interface configured to display on the WAP browser of FIG. 30;

FIG. 36 illustrates one example event status interface configured to display on the WAP browser of FIG. 30;

FIG. 37 illustrates an operation flow for a process for sending reminders to event invitees according to one embodiment of the present disclosure;

FIG. 38 illustrates an operation flow for a process for providing targeted advertisements according to one embodiment of the present disclosure;

FIG. 39 depicts an example invitation chain and corresponding event records according to one embodiment of the present disclosure;

FIG. 40 illustrates an operation flow for a process by which an invitee can invite additional people to an event according to one embodiment of the present disclosure;

FIG. 41 illustrates an operation flow for a process by which the organization device can track the invitation chain for an event according to one embodiment of the present disclosure;

FIG. 42 illustrates an example forward event interface according to one embodiment of the present disclosure;

FIG. 43 illustrates another example event status interface according to one embodiment of the present disclosure; and

FIG. 44 illustrates an example invitee status interface according to one embodiment of the present disclosure.

### DETAILED DESCRIPTION

In the following description of preferred embodiments, reference is made to the accompanying drawings that form a part hereof, and in which is shown by way of illustration specific embodiments in which the invention may be practiced. It is understood that other embodiments may be utilized and changes may be made without departing from the scope of the present disclosure.

In general, the present disclosure describes methods and systems for organizing an event. According to the disclosure, a user accesses an organization device and schedules a location-specific event. The user has the option of inviting event participants, who can send to the organization device a response regarding the participation status of the invitee. The organization device tracks the participation status of each invitee. The organization device can also provide the participation status of each invitee to other invitees. In some cases, the organization device can communicate with a portable, location-aware electronic device of one or more of the invitees. In such cases, the organization device can also track and provide the arrival status of these invitees.

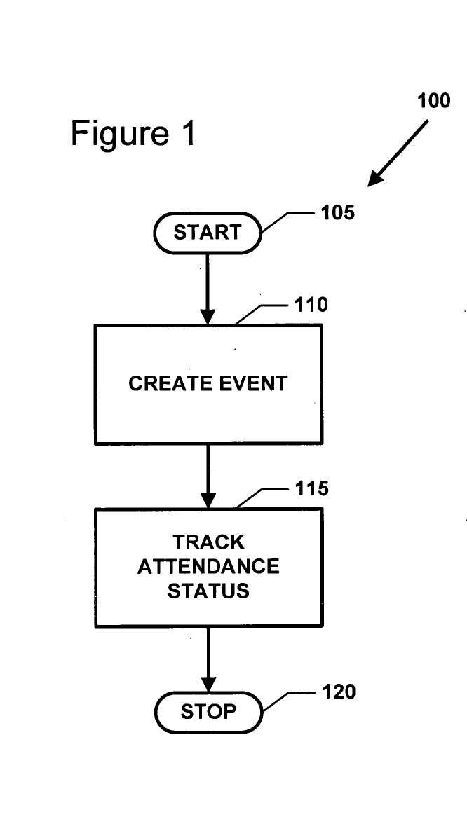

Referring now to the figures in general, FIG. 1 illustrates an operational flow for an example process 100 that can be implemented by embodiments of the present disclosure. The process 100 begins at start module 105 and proceeds to a create operation 110. The create operation 110 enables a user to create an event, such as that described below. A track operation 115 enables the user and/or event invitees to track the attendance status of other event invitees. As the term is used herein, attendance status refers to both participation status and arrival status, such as that described in more detail herein. The process 100 ends at stop module 120.

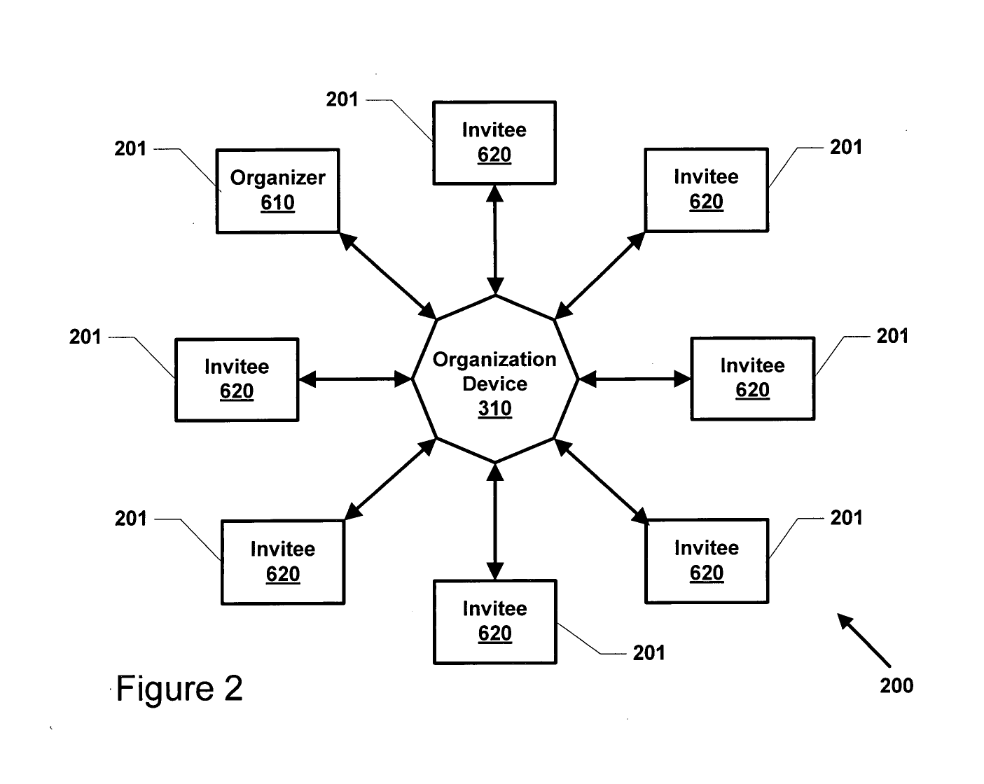

FIG. 2 illustrates an example user network 200 in which users 201, such as event participants, are communicatively coupled to an organization device 310. Event participants refer to both an event organizer 610 and individuals invited to the event, referred to as “invitees 620”. The event organizer 610 creates an event using the organization device 310 and sends invitations to the event invitees 620.

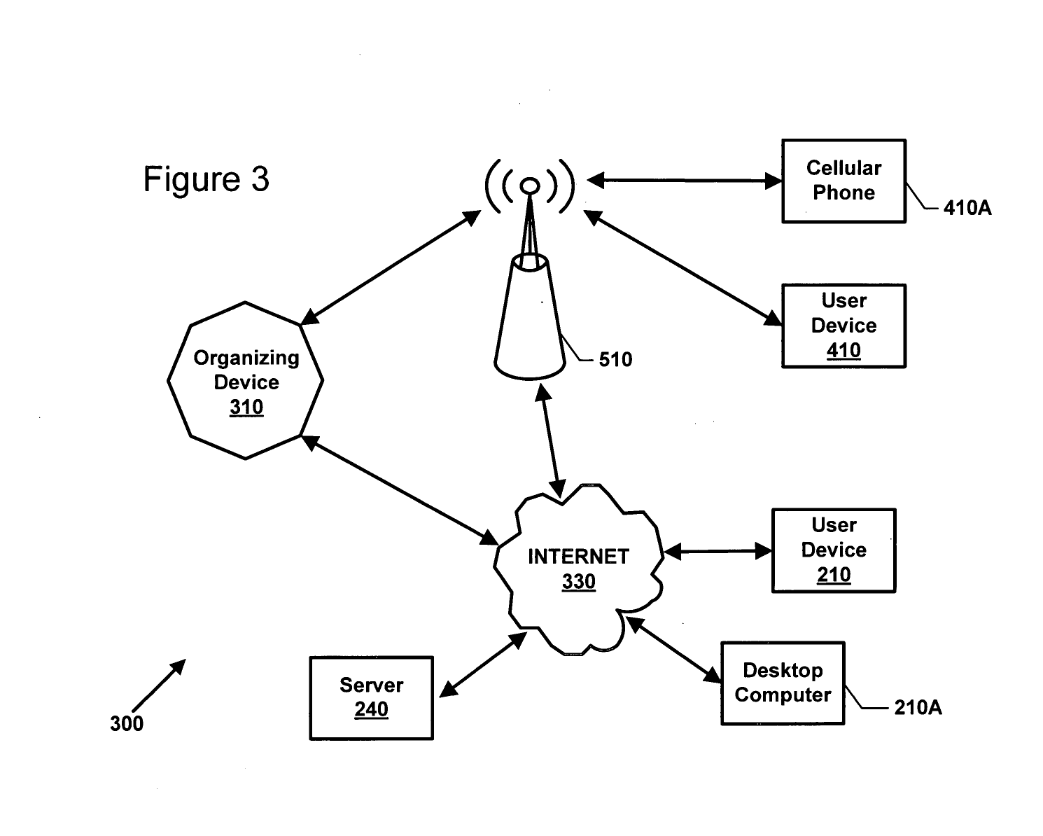

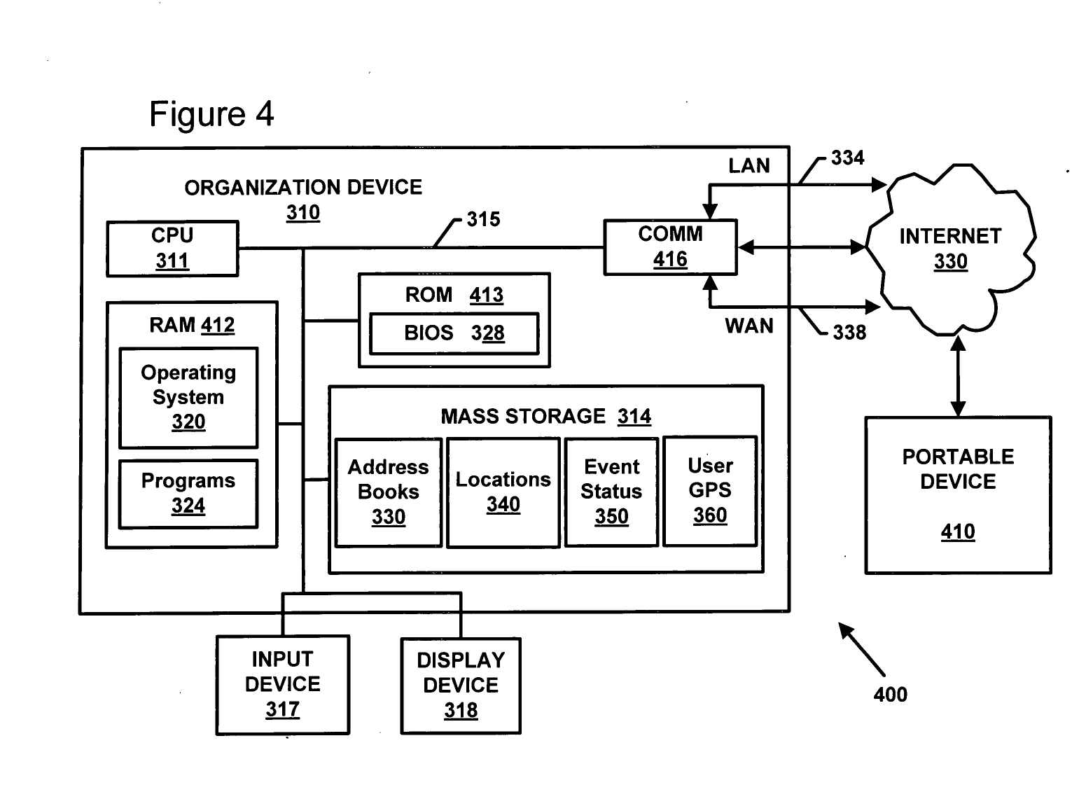

FIG. 3 is a schematic of one exemplary embodiment of a network 300 including multiple interconnected user devices. An organizing device 310, such as organization device 310 of FIG. 2, is configured to transmit and receive information and requests for information to and from user devices 210 and other computing devices, such as a server 240. In some example embodiments, the organization device is configured to transmit information over the Internet 330. In other example embodiments, the organization device 310 is configured to transmit information through a wireless carrier 510. One example embodiment of the organization device will be described in more detail with reference to FIG. 4.

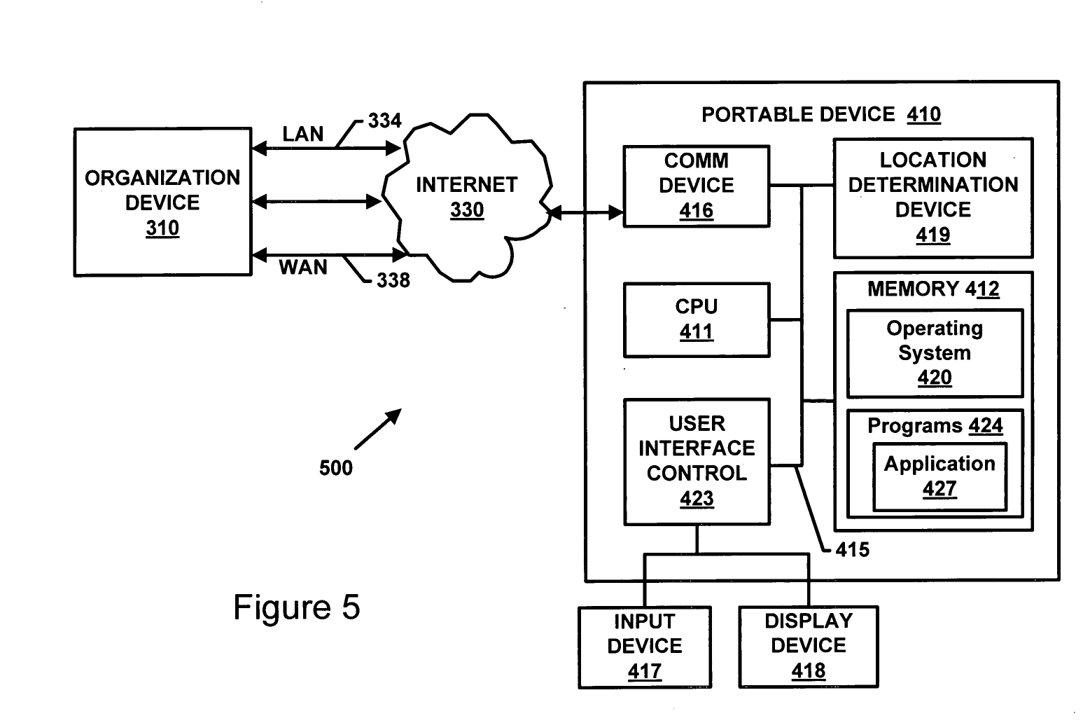

A user device 210 refers to a device associated with an event participant, such as participants 610, 620 of FIG. 2. Examples of user devices 210 include non-portable devices, such as desktop computers 21 OA. Further examples of user devices 210 include portable devices 410, such as cellular phones 41 OA, personal digital assistants (PDAs), and notebook computers. According to some embodiments, each user device 210, 410 communicates directly with other user devices 210, 410. According to other embodiments, however, the user devices 210, 410 communicate with one another through the organizing device. More information regarding possible portable user devices 410 will be provided herein with respect to FIG. 5.

In some example embodiments, the event organizer 610, FIG. 2, accesses the organization device 310 from a portable device 410, FIG. 3, such as cellular phone 410A. In other embodiments, the event organizer 610 accesses the organization device 310 from a non-portable user device 210, such as desktop computer 210A. In still other embodiments, the event organizer 610 accesses the organization device 310 directly using an input device, such as input device 317 of FIG. 4, of the organization device 310.

Referring to FIGS. 4-6, block diagrams of example hardware and operating environments in which different embodiments of the present disclosure can be practiced are illustrated. Some embodiments of the present disclosure are described in terms of a computer executing computer-executable instructions. However, some embodiments of the present disclosure can be implemented entirely in computer hardware in which the computer-executable instructions are implemented in read-only memory. Some other embodiments of the present disclosure can also be implemented in client/server computing environments where remote devices, linked through a communications network, perform tasks. Program modules can be located in both local and remote memory storage devices in a distributed computing environment.

FIG. 4 illustrates an example embodiment of an operating environment 400 for an organization device 310. Embodiments of the present disclosure are not limited to any particular type of organizing device 310. In some example embodiments, the organizing device 310 is a computer server. In varying embodiments, the organizing device 310 includes a PC-compatible computer, a MacOS®-compatible computer or a UNIX-compatible computer. The construction and operation of such computers are well known within the art. In some example embodiments, the organization device 310 can be operated using at least one operating environment to provide a graphic user interface including a user-controllable pointer. Such operating environments include operating systems such as versions of the Microsoft Windows® and Apple MacOS® operating systems. Embodiments of the present disclosure are not limited to any particular operating environment, however, and the construction and use of such operating environments are well known.

In such embodiments, the organizing device 310 includes a processing unit 311, such as a processor commercially available from Intel®, Motorola®, Cyrix® and other such companies, random-access memory (RAM) 312, read-only memory (ROM) 313, and one or more mass storage devices 314, and a system bus 315, that operatively couples various system components including the system memory to the processing unit 311. The RAM 312 can store an operation system 320 and one or more programs 324 executable by the organization device 310. The ROM 313 can store a basic input/output system (BIOS) 328. The processing unit 311 executes computer programs stored on the computer-readable media.

The mass storage devices 314 are more specifically types of nonvolatile storage media and can include a hard disk drive, a floppy disk drive, an optical disk drive, and a tape cartridge drive. The memory 312, 313 and mass storage devices 314 are types of computer-readable media. In some example embodiments, the mass storage devices 314 can store information such as one or more databases 330, 340, 350, 360. In one example embodiment, a mass storage device 314 of the organization device 310 stores an address book database 320, a locations database 340, an events database 350, and a user locations database 360. In another example embodiment, other databases (not shown) store information relating to a particular event, invitee participation status, and any other desired information.

An organizing device 310 can be operatively coupled to an input device 317 via the system bus 315. The input device 317 and the display device 318 are connected to the system bus 315. A user can enter commands and information into the organization device 310 through input devices 317 such as a pointing device and a keyboard. Other input devices (not shown) can include a mouse device, microphone, joystick, game pad, touch pads, trackballs, scanner, remote control, point stick, or the like. For example, a keyboard permits entry of textual information into the organizing device 310, as known within the art, and embodiments of the present disclosure are not limited to any particular type of keyboard or input device.

The organizing device 310 can also be operatively coupled to a display device 318 over the system bus 315. The display device 318 permits the display of information, including computer, video, textual, and other information, for viewing by a user of the computer. Embodiments of the present disclosure are not limited to any particular display device 318. Such display devices 318 include cathode ray tube (CRT) displays (monitors), as well as flat panel displays such as liquid crystal displays (LCD's). Other output devices can typically include printers and speakers.

Furthermore, the organizing device 310 can be communicatively connected to the Internet 330 via a communication device 316. Internet connectivity is well known within the art. In one example embodiment, the communication device 316 is a modem that responds to communication drivers to connect to the Internet via what is known in the art as a “dial-up connection.” In another example embodiment, the communication device 316 is an Ethernet or similar hardware (network) card connected to a local-area network (LAN) that itself is connected to the Internet via what is known in the art as a “direct connection” (e.g., T1 line, etc.). In yet another example embodiment, the communication device 316 includes a wireless modem and hub to connect to the Internet via what is known in the art as a “wireless connection.” Embodiments of the present disclosure are not limited to a particular type of communications device 316.

The organizing device 310 can have at least one web browser application program executing within at least one operating environment, to permit users of the organizing device 310 to access an intranet or the Internet 330 as addressed by a Universal Resource Locator (URL) addresses. Such browser application programs include Netscape Navigator® and Microsoft Internet Explorer®.

The organizing device 310 can operate in a networked environment using logical connections to one or more remote computers or other electronic devices, such as portable device 410. Logical connections are achieved via the communication device 316. The remote computer can be another computer, a server, a router, a network PC, a client, a peer device, a mobile device such as a cell phone or PDA, or any other suitable network node. The logical connections depicted in FIGS. 4 and 5 include a local-area network (LAN) 334 and a wide-area network (WAN) 338. Such networking environments are commonplace in offices, enterprise-wide computer networks, intranets and the Internet.

When used in a LAN-networking environment 334, the organizing device 310 and remote electronic device 410 are connected to the local network 334 through a network interface or adapter, which is one type of communications device 316. When used in a conventional WAN-networking environment, the organizing device 310 and remote electronic device 410 communicate with a WAN 338 through modems, which are another type of communications device 316. The modem of the organizing device 310, which can be internal or external, is connected to the system bus 315. In a networked environment, program modules depicted relative to the organizing device 310, or portions thereof, can be stored in the remote memory storage device.

FIG. 5 illustrates a block diagram of an example hardware and operating environment 500 in which different embodiments of a portable device 410 can be practiced. Embodiments of the present disclosure are not limited to any particular type of portable device 410. In one example embodiment, the portable device 410 is a cellular phone. In varying embodiments, the portable device 410 is a mobile device capable of accessing the Internet, sending text messages, receiving and transmitting locations information, and taking digital pictures. The construction and operation of such portable devices 410 are well known within the art.

In general, the portable device 410 includes a processing unit (i.e., CPU) 411, memory storage 412, and a system bus 415 that operatively couples various system components including the system memory 412 to the processing unit 411. The memory 412 can store an operation system 420 and one or more programs 424 executable by the processing unit 411. In some embodiments, the processing unit 411 executes computer programs stored on the computer-readable media. One example of a program 424 is an application 427 enabling the wireless device to access and interface with the organization device 310. Such an application 427 will be discussed in more detail herein.

In some example embodiments, the portable device 410 can be operated using at least one operating environment to provide a graphic user interface. In such embodiments, the portable device 410 includes a user interface control 423. However, embodiments of the present disclosure are not limited to any particular operating environment and the construction and use of such operating environments are well known within the art.

The portable device 410 can be operatively coupled to an input device 417 via the system bus 415. A user can enter commands and information into the organization device 410 through input devices 417 such as a pointing device and a keyboard. In some embodiments, the input device 417 can include a microphone for obtaining auditory information from a user. Other input devices (not shown) can include a mouse device, game pad, touch pads, trackballs, camera, remote control, point stick, or the like. For example, a keyboard permits entry of textual information into the portable user device 410, as known within the art, and embodiments of the present disclosure are not limited to any particular type of keyboard.

The portable user device 410 can also be operatively coupled to a display device 418 over the system bus 415. The display device 418 permits the display of information, including graphical, textual, and other information, for viewing by a user of the computer. In some embodiments, the display device 418 includes a speaker for presenting auditory information to a user. Embodiments of the present disclosure, however, are not limited to any particular display device 418.

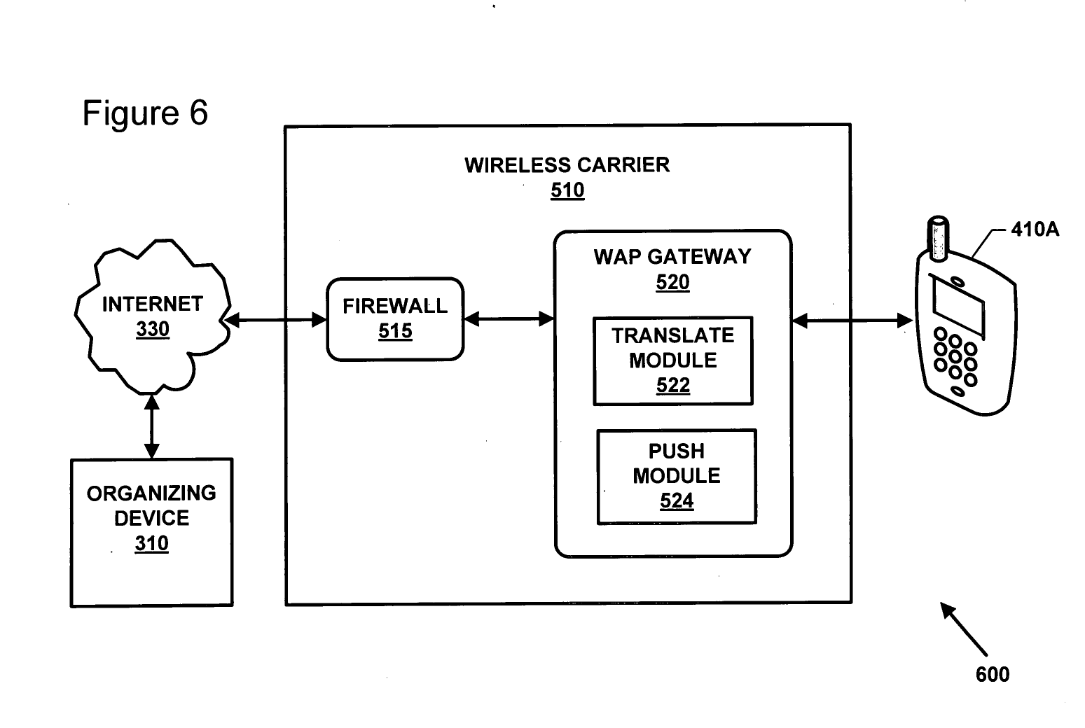

Furthermore, the portable device 410 can be communicatively connected to other devices, such as other portable devices 410, other non-portable user devices 210, and other non-user devices 240, via a communication device 416. In some example embodiments, the communication device 416 includes a radio transmitter and receiver for transmitting and receiving electromagnetic waves carrying speech and data packets. Embodiments of the present disclosure are not limited to a particular type of communications device 416. In one example embodiment, the communication device 416 couples the portable device 410 to the Internet 330. Internet connectivity is well known within the art and additional details regarding the Internet connectivity are discussed with reference to FIG. 6.

The portable device 410 can have at least one web browser application program executing within at least one operating environment, to permit users of the portable device 410 to access the Internet 330. For example, in some embodiments, a portable device 410 accesses the Internet 300 using a Wireless Application Protocol (WAP). In other example embodiments, the portable device 410 can send and receive text messages via a text messaging service, such as SMS and GMS. In still other example embodiments, the portable device 410 can send and receive email messages. Such features for portable devices are well known in the art and the invention is not limited to a particular system for implementing these features.

In some example embodiments, the portable device 410 includes a location determination device 419 operably coupled to the CPU 411 via the system bus 415. The location determination device 419 is configured to ascertain the current location of the portable device 410. One example location determination device 419 includes a GPS (Global Positioning System) transceiver. The portable device 410 can determine its current location using the location determination device 419 and transmit its location using the communication device 416 to an organization device 310 or other device.

FIG. 6 illustrates one example embodiment of an operating environment 600 through which a portable device 410, such as a WAP- and GPS-enabled cellular phone 410A, can connect to the organization device 310, the Internet 330, or another device through a wireless carrier 510. In general, the wireless carrier 510 maintains a WAP gateway 520 and a firewall 515. The WAP gateway is device independent and service independent.

In some example embodiments, a WAP gateway 520 includes a translate module 522 and a push module 524. The translate module 522 encodes and decodes WAP pages between the cell phone browser and the web server to which the cell phone is connecting. For example, in one embodiment, the WAP gateway 520 translates HTML (i.e., hyper-text markup language) to WML (i.e., wireless markup language), and vice versa. The push module 524 directs the user of a portable device 510 to a WAP address where content can be stored ready for viewing or downloading. Non-limiting examples of content stored at a WAP address include web pages, multimedia content, and Java applications.

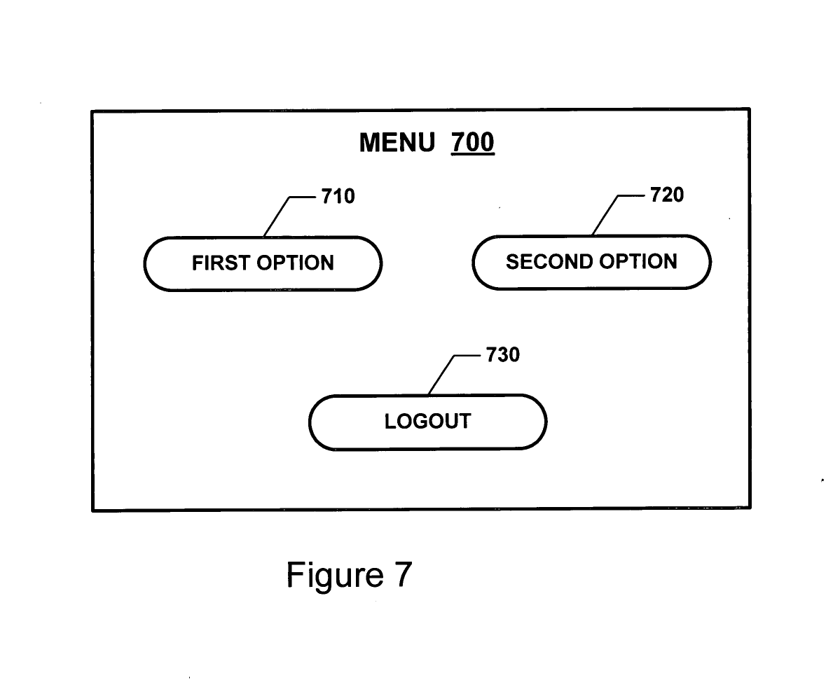

Referring now to FIGS. 7-18, an event organizer 610 can schedule an event and invite participants (i.e., invitees) 620 to the event using the organization device 310. The organization device 310 executes a number of processes at the request of the event organizer 610. In some example embodiments, the event organizer 610 requests the organization device 310 to perform the processes through a series of interfaces displayed on a display screen, such as display screen 318 of FIG. 4, of the organization device 310. Examples of some of these processes and interfaces are disclosed herein with respect to claims 7-18.

FIG. 7 illustrates one example embodiment of a menu interface 700 capable of being displayed to the event organizer 610. In this embodiment, the menu interface 700 displays a first option 710, a second option 720, and a logout option 730. The logout option 730 enables the event organizer 610 to end communication with the organization device 310. Examples of different options displayed on the menu interface 700 will be discussed in detail below.

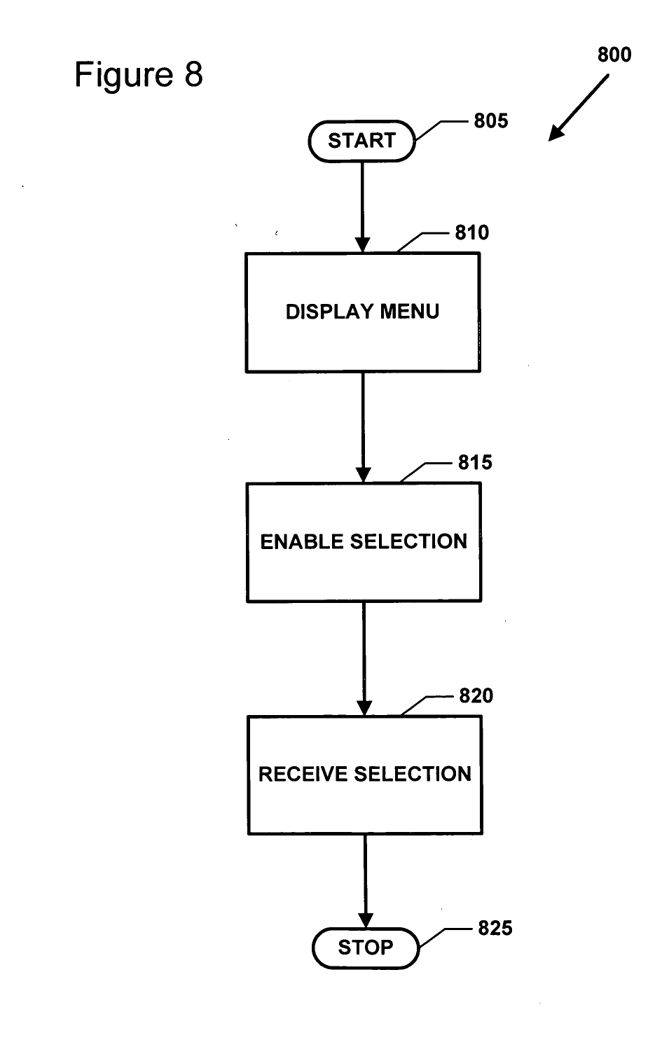

FIG. 8 illustrates an operation flow for a process 800 for accessing a menu, such as menu interface 700, and selecting a menu option. The process 800 beings at start module 805 and proceeds to display operation 810. The display operation 810 displays to the event organizer 610 a menu interface including at least two options. An enable operation 815 provides an interface tool with which the event organizer 610 can select one of the options displayed on the menu. In some embodiments, the display operation 810 presents the options in the form of buttons and the enable operation 815 allows a user to select one of the options by pressing or “clicking” on the corresponding button. In other embodiments, however, options can be selected via radio buttons, hyper-links, and other suitable interface tools. A receive operation 820 receives the selection from the event organizer 610. The process ends at stop module 825.

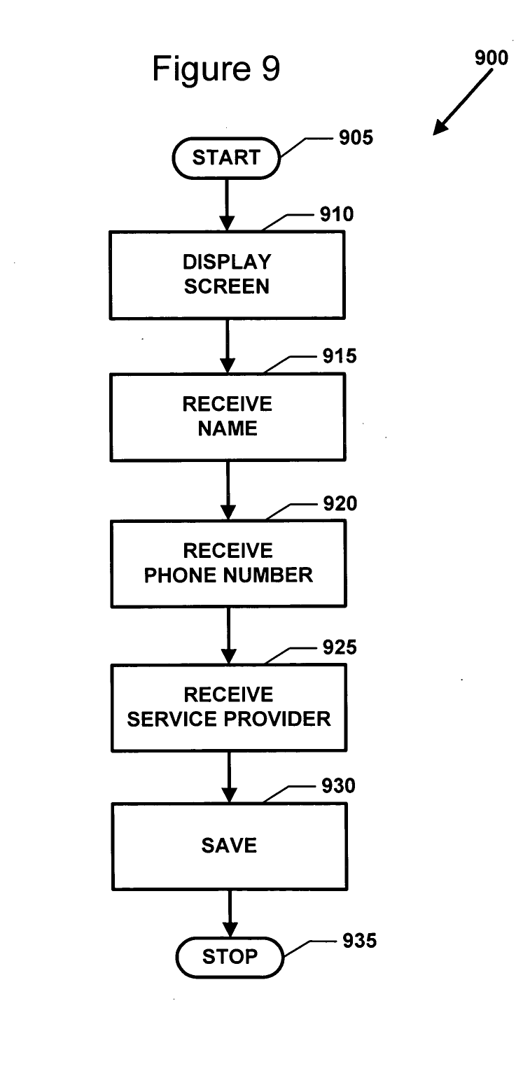

Referring now to FIGS. 9-13, the event organizer 610 creates and maintains a contact list (i.e., or address book) of individuals the event organizer 610 may wish to invite to an event. In some example embodiments, the contact list is stored in a database, such as the address book database 330, on the organization device 310 (FIG. 4). In other example embodiments, the contact list is stored in the memory 412 of the portable device 410 (FIG. 5) of the event organizer 610. As the term is used herein, a “contact” refers to either an individual or a group of individuals for whom contact information is available to the event organizer 610.

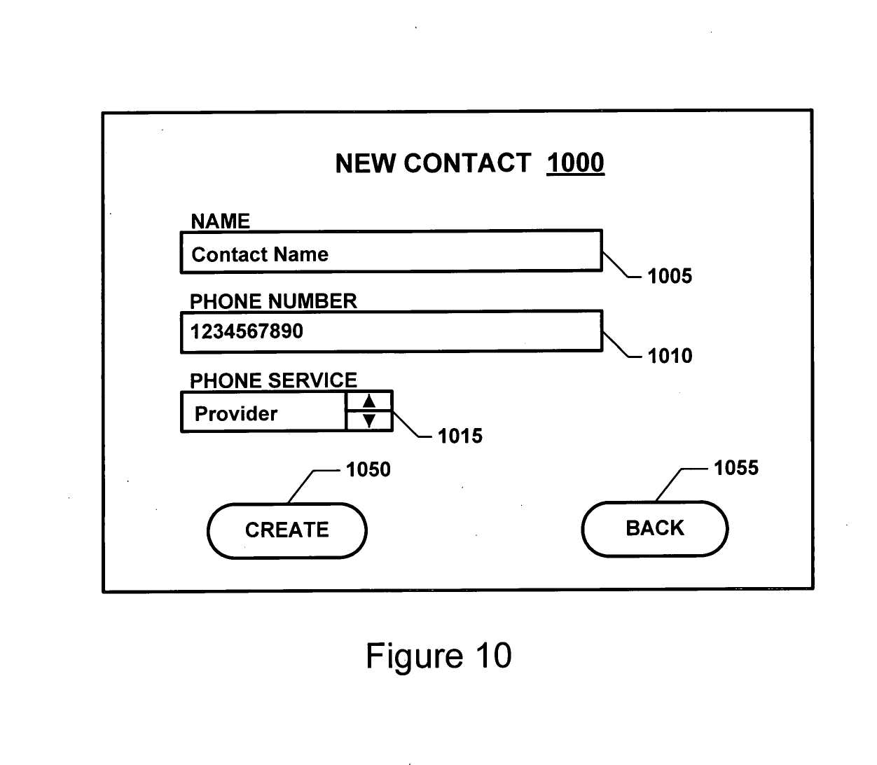

FIG. 9 illustrates an operational flow for a process 900 for adding an individual to the contact list. The process 900 begins at a start module 905 and proceeds to a display operation 910, which displays to the event organizer 610 a new contact interface. One example of such an interface is depicted as display screen 1000 in FIG. 10. The process 900 collects information that will enable the event organizer 610 to send information to the individual being added.

A first receive operation 915 receives the name of the individual. A second receive operation 920 receives the phone number of the individual. A third receive operation 925 receives the service provider of the individual. In some embodiments, the second and third receive operations 920, 925 obtain information from the user adding the contact. In other embodiments, however, the organization device, such as organization device 310 of FIG. 2, can access the contact information of each user. In one example embodiment, the organization device stores contact information for each user.

In another example embodiment, second and third receive operations 920, 925 can obtain information pertaining to a new contact from the address books of other users if the other users have such information in their address books. For example, if Mary Planner wanted to add Mongol A as a contact to her address book, and if Genghis Kahn already had Mongol A listed as a contact, then receive operations 920, 925 could obtain Mongol A's service provider or phone number from Genghis Kahn's address book.

In still other embodiments, however, the process 900 can collect other types of information, such as a mailing address, an email address, or an alternative phone number corresponding to the individual. A save operation 930 stores the collected information. For example, in some embodiments, the save operation 930 adds an entry in an address book stored on the organization device 310. The process 900 ends at a stop module 935.

FIG. 10 illustrates one example embodiment of a “New Contact” interface 1000 capable of being displayed to the event organizer 610. The screen 1000 includes text boxes 1005, 1010 into which the event organizer 610 can type the name and phone number, respectively, of the individual. In some embodiments, the interface 1000 also includes a text box (not shown) into which the event organizer 610 can enter the service provider of the new contact. In other embodiments, the screen 1000 includes a drop down box 1015 from which the event organizer 610 can select the appropriate service provider from a predetermined list of service providers. In still other embodiments, other text boxes and other interface tools (not shown) can be provided for entering any desired contact information relating to the individual being added.

In some embodiments, the new contact interface 1000 also includes interface tools enabling the event organizer 610 to add the new contact to the address book and to return to the menu screen 800 without adding the new contact. For example, in one embodiment, the interface screen 1000 includes a create button 1050 and a back button 1055. In other embodiments, other navigation tools (not shown) can be added as desired.

In some embodiments, a user, such as a user 201 of user network 200, will not have any contacts stored in her address book until she creates a new contact. In other embodiments, however, contact information is automatically created for all users who have the user listed in their address books. For example, in such an embodiment, if a first user, Mary Planner, was listed as a contact for a second user, Genghis Kahn, then contact information for Mr. Kahn would be automatically added to Ms. Planner's address book.

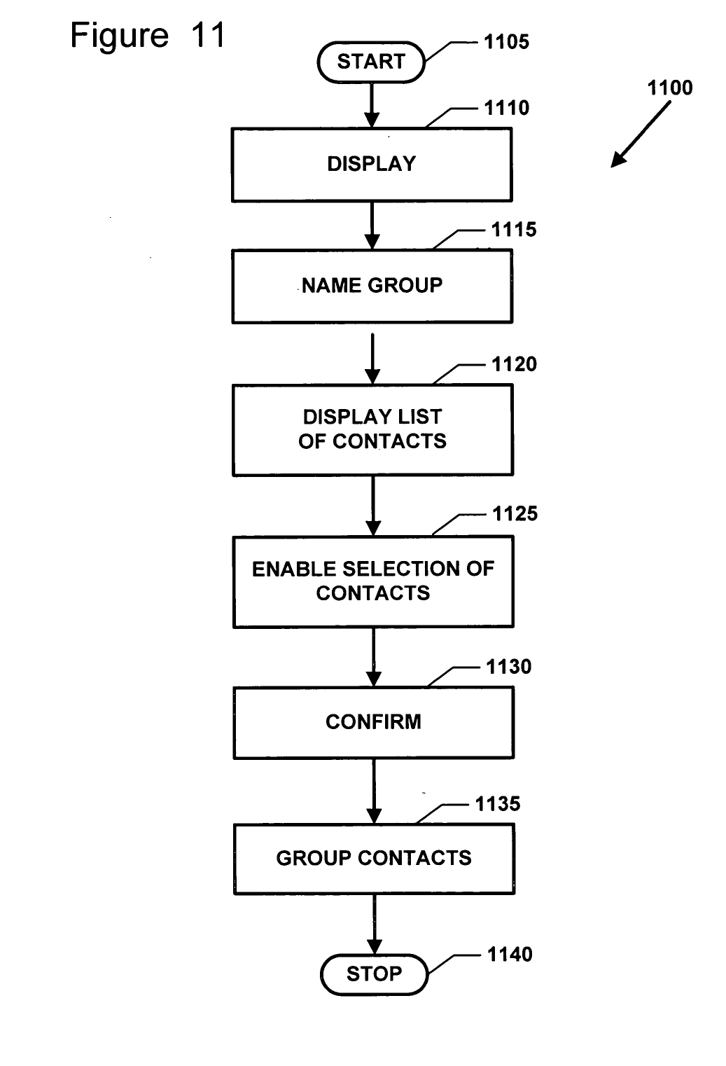

Referring to FIGS. 11-13, individual contacts can be associated together to form a group. Thereafter, the event organizer can invite the members of the group without having to select and identify each individual member. FIG. 11 illustrates an operational flow for a process 1100 for creating a grouping of individuals from the contact list of the event organizer 610.

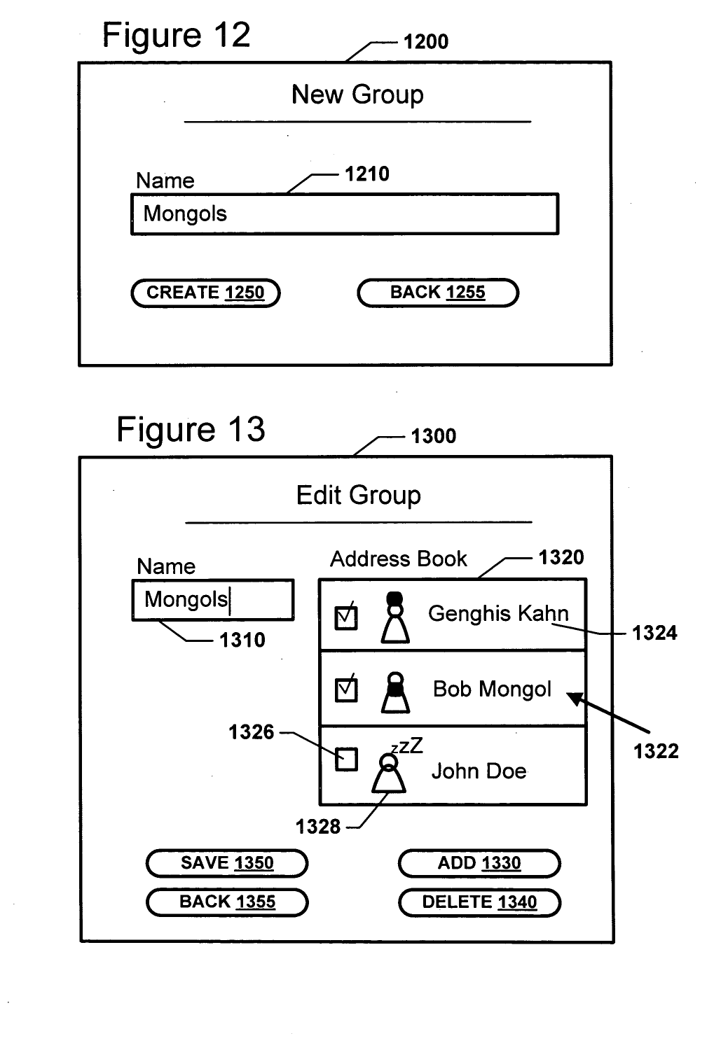

The process 1100 begins at a start module 1105 and proceeds to a first display operation 1110, which displays a group interface to the event organizer 610. One example of such an interface is depicted as new group interface 1200 in FIG. 12. A name operation 1115 enables the event organizer 610 to input a designation by which the group will be known.

A second display operation 1120 provides a list of existing contacts, such as list 1320 of FIG. 13, from the contact list of the event organizer 610. In some embodiments, the second display operation 1120 displays the list of contacts on the interface displayed in the first display operation 1110. In other embodiments, the second display operation 1120 provides a new display, such as the “Edit Group” interface 1300 shown in FIG. 13.

An enable operation 1125 provides the event organizer 610 with an interface tool arrangement for selecting one or more contact entries, such as contact entry 1322 in FIG. 13. In some embodiments, the enable operation 1125 provides checkboxes, such as checkboxes 1326 in FIG. 13, to allow the event organizer 610 to select one or more entry. In other embodiments, the enable operation 1125 provides radio buttons, hyperlinks, or other such tools to allow the event organizer 10 to select entries. In still other embodiments, the enable operation 1125 provides an interface arrangement for deselecting one or more entries from being included in the group. For example, in one embodiment, the enable operation 1125 provides a deselect button, such as deselect button 1340 in FIG. 13, that allows an event organizer 610 to remove or exclude one or more entries from the group.

When the event organizer 610 has finished selecting the contacts desired to be included in the group, a confirm operation 1130 enables the event organizer 610 to indicate that the selected entries should be associated with the group. A group operation 1135 associates the selected contact entries with the group name. The process 1100 ends at a stop module 1140.

FIGS. 12 and 13 illustrate example “Group” interfaces provided by the display operations 1110, 1120 of process 1100. In some embodiments, forming a group involves first providing a group designation and then adding contacts to the group. The above steps can be performed using one or more interfaces. For example, FIG. 12 illustrates an interface 1200 for creating a new group designation and FIG. 13 illustrates an interface 1300 for defining which contacts belong to the group created using interface 1200. In other embodiments, however, the creation and definition steps can be executed using the same interface or other suitable interfaces (not shown).

FIG. 12 illustrates one example embodiment of a new group interface 1200 provided by the first display operation 1110 in process 1100. The interface 1200 includes an interface tool 1210, such as a textbox, enabling an event organizer 610 to designate a name for the group. As with the “New Contact” interface 1000 of FIG. 10, the interface 1200 includes interface arrangements for enabling the event organizer 610 to add the new group contact to the address book and to return to the menu screen 800 (FIG. 8) without adding the new group contact. For example, in the embodiment shown in FIG. 12, the interface 1200 includes a create button 1250 and a back button 1255. In other embodiments, other interface and navigation tools (not shown) can be used as desired.

FIG. 13 illustrates one example embodiment of an interface 1300 provided by the second display operation 1120 of process 1100. In some embodiments, the interface 1300 is an “Edit Group” interface that is provided to the event organizer 610 separately from the new group interface 1200. The display screen 1300 provides an interface tool 1310 enabling an event organizer 610 to provide or select the name designation of the group the event organizer 610 desires to edit.

The display screen 1300 also provides a list 1320 of contacts previously provided by the event organizer 610. The list 1320 includes one or more entries 1322 and each entry 1322 has a corresponding interface tool 1326. In some embodiments, each entry 1322 also includes text 1324 indicating a contact name and an icon 1328. In one example embodiment, the icon 1328 indicates whether the contact is an individual or a group. In other embodiments, the icon 1328 is unique to each contact. In one such embodiment, the event organizer 610 chooses the icon 1328 for each contact. In another such embodiments, each individual contact chooses an icon 1328 to represent the individual.

In the example interface 1300 shown in FIG. 13, the interface 1300 includes an “add” button 1330 and a “delete” button 1340 enabling the event organizer 610 to associate selected entries 1322 with and dissociate selected entries 1322 from the designated group. In other embodiments, however, different interface tools can be provided to enable the event organizer 610 to forms groups. In the example shown, a save button 1350 is provided to enable the event organizer 610 to indicate that the event organizer 610 has finished forming the group. A back button 1355 is also provided to enable the event organizer 610 to return to the main menu 1000 without saving the group information.

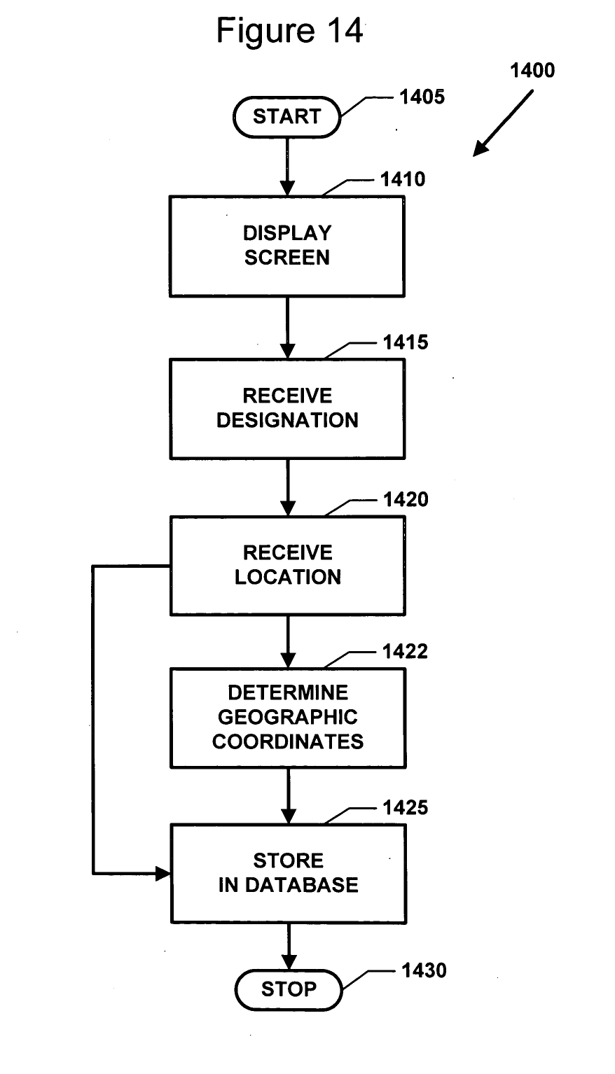

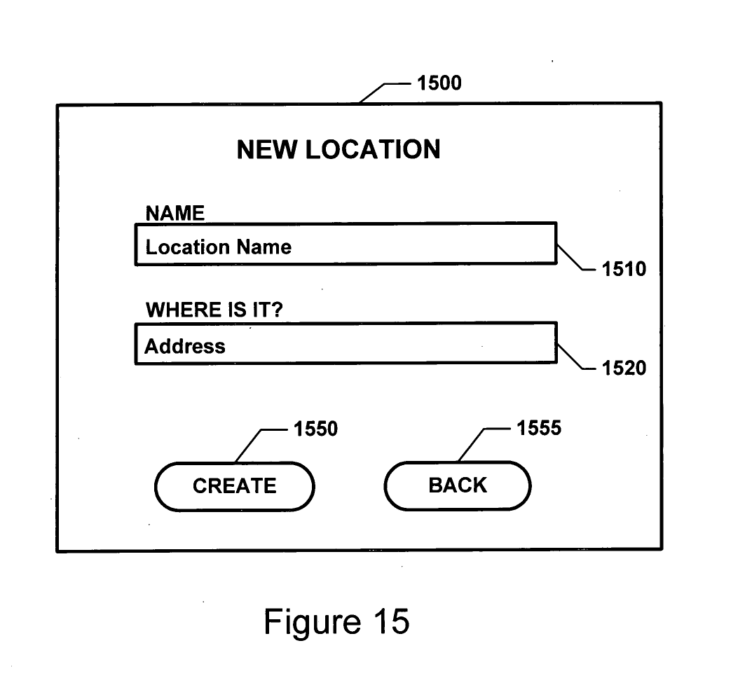

Referring now to FIGS. 14 and 15, the event organizer 610 creates and maintains a list of locations at which events can be scheduled. In some example embodiments, the locations list is stored in a database, such as the locations database 330, on the organization device 310 (FIG. 4). In other example embodiments, the locations list is stored in the memory 412 of the portable device 410 (FIG. 5) of the event organizer 610.

FIG. 14 illustrates an operational flow for a process 1400 for adding a new location to the locations list associated with the event organizer 610. The process 1400 beings at a start module 1405 and proceeds to a display operation 1410. The display operation 1410 provides a “New Location” interface to the event organizer 610. One example “New Location” interface is depicted in FIG. 15. Of course, the invention is not so limited and any suitable interface can be used.

Continuing with the process 1400, a first receive operation 1415 receives a name designating the location to be added. For example, in one example embodiment, the receive operation 1415 receives a name input into an interface tool, such as textbox 1510 of FIG. 15. A second receive operation 1420 receives information indicating the geographic position of the location. In some example embodiments, the second receive operation 1420 receives geographic coordinates (e.g., latitude and longitude) of the location. In such embodiments, the process 1400 proceeds to a store operation 1425.

In other example embodiments, the second receive operation 1420 receives an address associated with the location. In some such embodiments, the process 1400 proceeds to a geo-locate operation 1422 that determines the geographic coordinates of the location based on the received address. In other such embodiments, however, the process 1400 proceeds to the store operation 1425 without determining geographic coordinates for the location. In still other embodiments, the second receive operation 1420 receives a link to a graphical portrayal of the geographic position of the location (e.g., an electronic map or picture).

A store operation 1425 encodes both the name and the geographic position information in memory. In some embodiments, the store operation 1425 adds an entry in the locations database 330 of the organization device 310. In other embodiments, the store operation 1425 encodes the received designation and corresponding geographic information into the memory 412 of the portable device 410 of the event organizer 610. The process 1400 ends at stop module 1430.

FIG. 15 depicts one example embodiment of a “New Location” interface, such as the interface provided by display operation 1410. The example interface 1500 includes a first interface tool 1510 enabling the event organizer 610 to provide a location name designation. The example interface 1500 also includes a second interface tool 1520 enabling the event organizer 610 to enter a corresponding geographic position.

In some embodiments, the second interface tool 1520 is configured to accept text, for example, an address associated with the location. In other embodiments, the second interface tool 1520 is configured to accept a hyperlink associated with a virtual map or other graphical depiction. In one example embodiment, the second interface tool 1520 is configured to accept a URL including geo-positioning information. In still other embodiments, the second interface tool 1520 is configured to determine the current location of the portable device 410 of the event organizer 610.

The display screen 1500 also includes interface tools for enabling the event organizer 610 to save the new location and to return to the menu screen 800 (FIG. 8) without saving the new location. For example, in one embodiment, the display screen 1500 includes a create button 1550 and a back button 1555. In other embodiments, other navigation tools (not shown) can be used as desired.

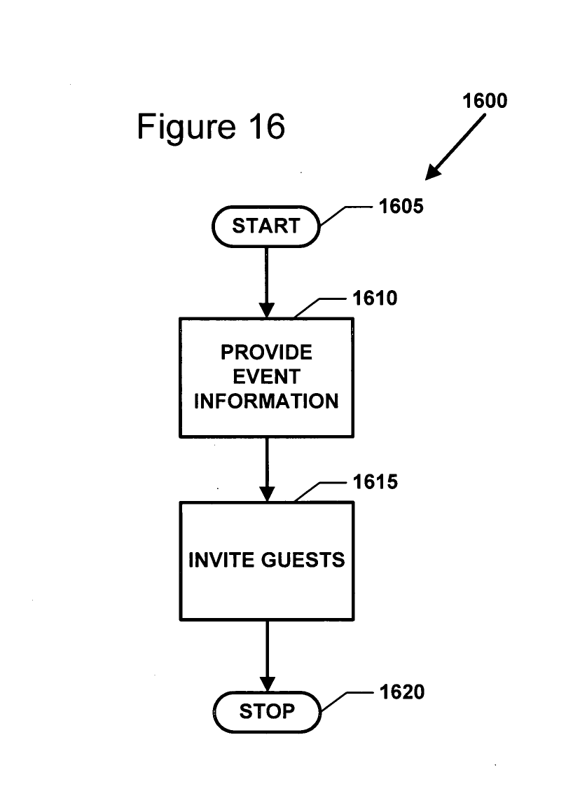

Referring now to FIGS. 16-18, the event organizer 610 can create and schedule one or more events. FIG. 16 illustrates an operational flow for a process 1600 by which the event organizer 610 creates an event. The process 1600 begins at a start module 1605 and proceeds to a receive operation 1610. The receive operation 1610 obtains from the event organizer 610 information specifying the time and location of an event. The receive operation 1610 also obtains from the event organizer 610 one or more contacts whom the event organizer 610 desires to invite to the event.

An invite operation 161 5 transmits invitations to each of the contacts (i.e., invitees) 620 provided by the event organizer 610 in the receive operation 1610. In some embodiments, the invite operation 1615 sends a text message to user devices, such as user devices 210 of FIG. 3, of one or more contacts indicating that the contact is invited to the event. In one such embodiment, the text message identifies the event organizer 610, the location at which the event is to take place, and the date and time at which the event is to take place. In other embodiments, the invite operation 1615 sends a text message including a hyperlink to a website providing the event information. In still other embodiments, the invite operation 1615 sends an email or other type of message providing the event information to the invited contacts 620. The process 1600 ends at a stop module 1620.

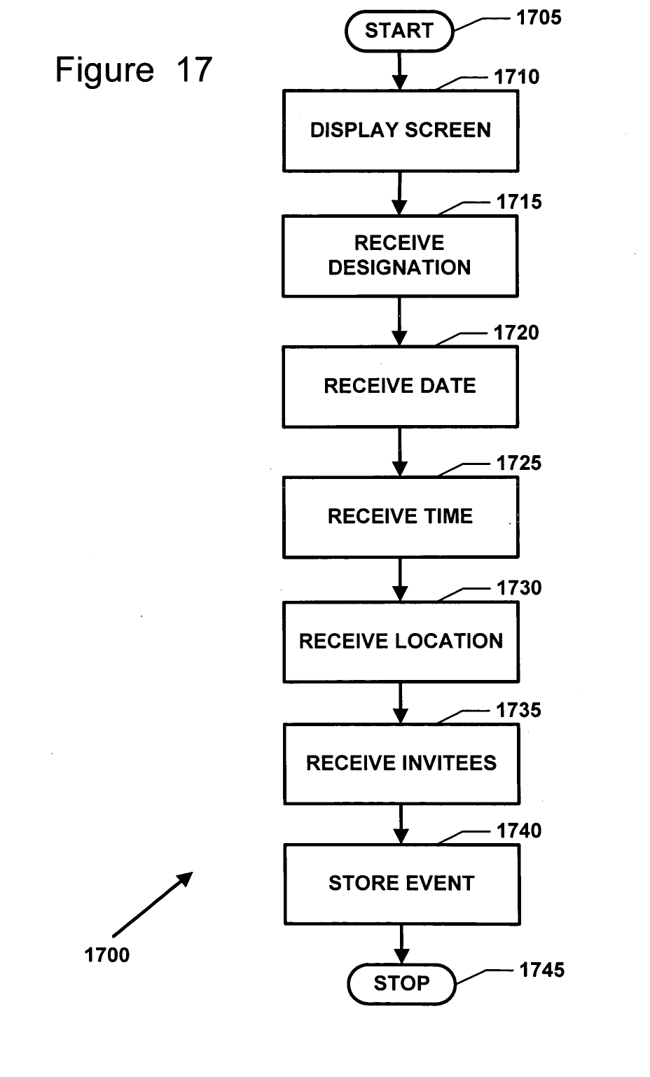

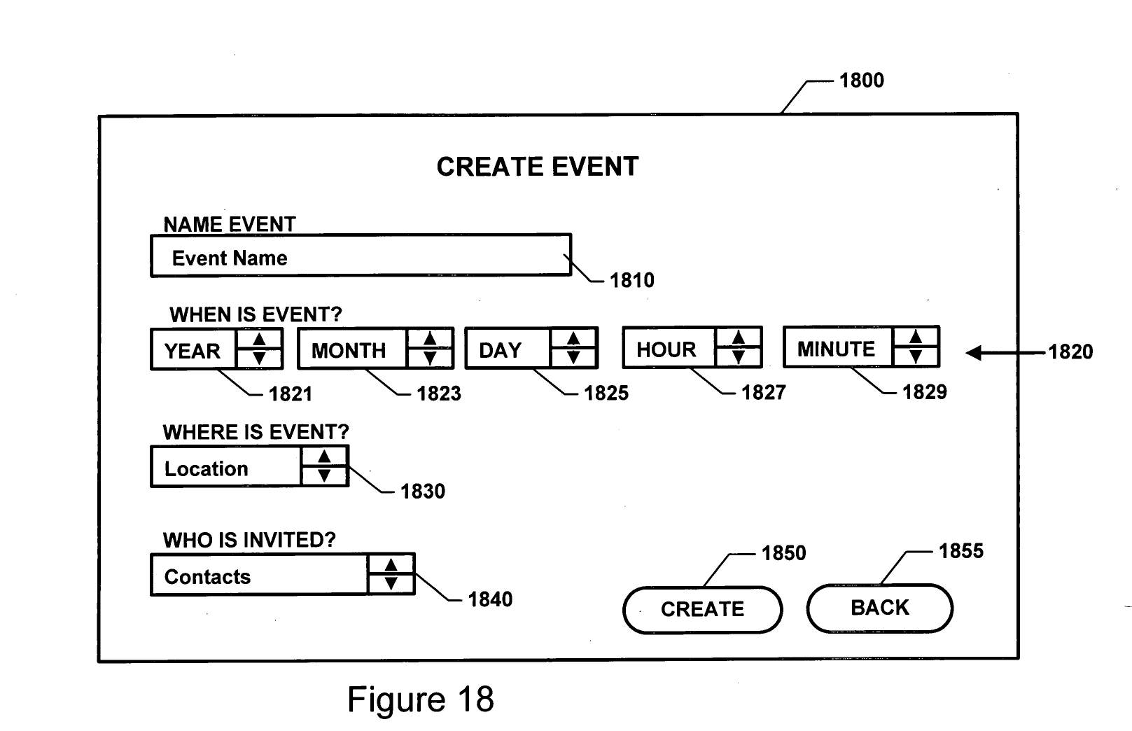

FIG. 17 illustrates an operational flow for a process 1700 for executing the receive operation 1610 of the process 1600. The process 1700 begins at a start module 1705 and proceeds to a display operation 1710. The display operation 1710 provides to the event organizer 610 an interface, such as interface 1800 of FIG. 18. Next, a first receive operation 1715 receives input from the event organizer 610 designating the name of the event. A second receive operation 1720 receives additional data from the event organizer 610 indicating the date on which the event will occur. A third receive operation 1725 receives from the event organizer 610 a time selection indicating the time at which the event will occur.

A fourth receive operation 1730 receives information indicating the location at which the event will occur. In some embodiments, the event organizer 610 selects a location entry from the list of locations associated with the event organizer 610. In other embodiments, the fourth receive operation 1730 determines the current geographic location of the portable device 410 of the event organizer 610. A fifth receive operation 1735 receives information indicating which of the contacts associated with the event organizer 610 are invited to the event. A store operation 1740 adds a new entry to a list of events associated with the event organizer 610. The process 1700 ends at a stop module 1745.

FIG. 18 depicts one example embodiment of an interface provided to the event organizer 610 by the display operation 1710 of process 1700. The “Create Event” interface 1800 includes a first interface tool 1810 configured to enable the event organizer 610 to provide a name designation for the event. The screen 1800 further includes an interface arrangement 1820 enabling the event organizer to provide scheduling information. In some embodiments, the interface arrangement 1820 includes interface tools 1821, 1823, 1825, 1827, 1829 configured to enable the event organizer to specify the year, month, day, hour, and minute, respectively, at which the event is to begin. In the example shown, the interface tools 1821, 1823, 1825, 1827, 1829 include dropdown menus, which are well known in the art. Of course, other suitable interface tools could also be used.

The “Create Event” interface 1800 also includes an interface tool 1830 configured to enable the event organizer 610 to indicate the geographic location of the event. For example, in one example embodiment, the interface tool 1830 includes a dropdown menu listing all locations included on the locations list associated with the event organizer 610. In another example embodiment, the interface tool 1830 includes a button by which the event organizer 610 can trigger the organization device 310 to determine the current location of the portable device 410 of the event organizer 610. In other embodiments, however, other interface tools, such as textboxes, could also be used to receive information indicating the desired location.

In some embodiments, the “Create Event” interface 1800 also includes an interface tool 1840 configured to enable the event organizer 610 to indicate contacts that the event organizer 610 desires to invite to the event. In the example shown in FIG. 18, the interface tool 1840 includes a dropdown menu listing each of the contacts included in the address book of the event organizer 610. In other embodiments, however, any suitable interface tool can be used to indicate which contacts should be invited to the event.

The interface 1800 also includes interface tools for enabling the event organizer 610 to store the new event (and corresponding information) on the organization device 310 (FIG. 3) or to return to the menu screen 800 (FIG. 8) without saving the new event. For example, in one embodiment, the interface 1800 includes a create button 1850 and a back button 1855. In other embodiments, other navigation tools (not shown) can be used as desired.

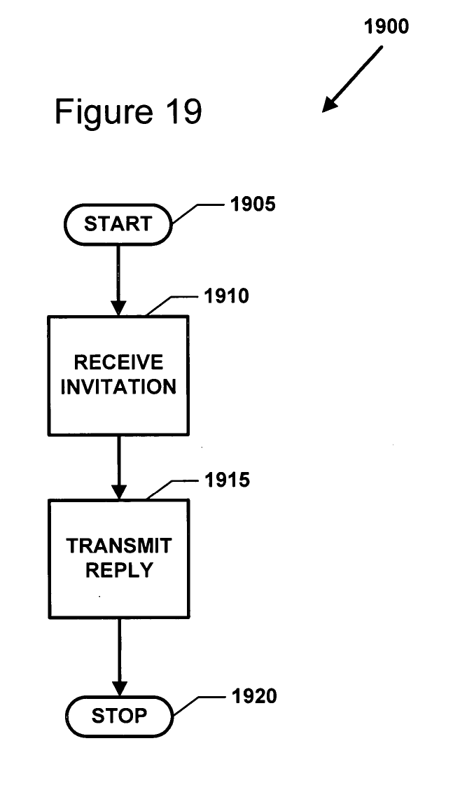

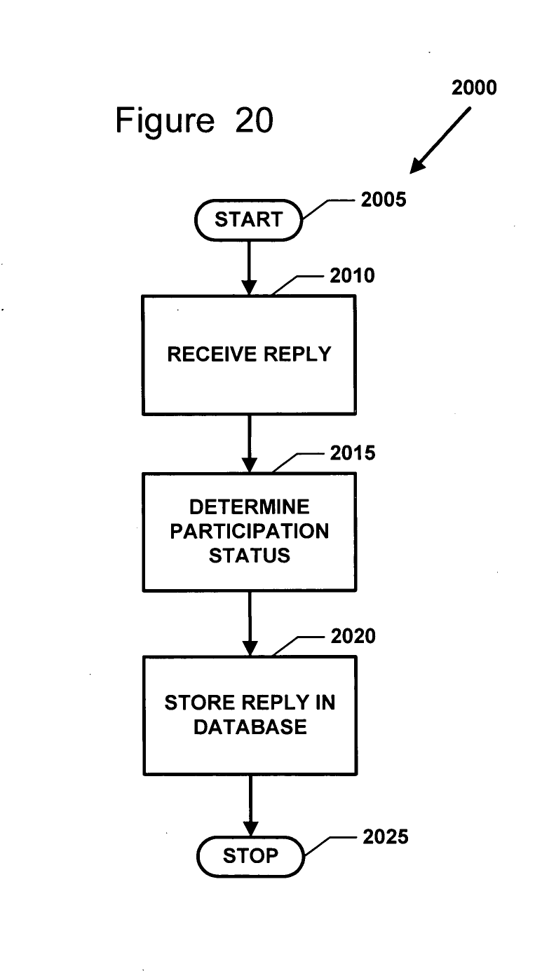

Referring now to FIGS. 19 and 20, the organization device 310 transmits invitations to and tracks responses received from the event invitees 620. In some example embodiments, these processes can be executed by a portable device belonging to an event participant, such as a cellular phone 410A of FIG. 3, and an organization device 310. In other example embodiments, these processes can be executed by a non-portable device belonging to an event participant, such as a desktop computer 210A of FIG. 3, and an organization device 310.

FIG. 19 illustrates an operational flow for a process 1900 by which an invitee receives an invitation to an event. The process 1900 begins at a start module 1905 and proceeds to a receive operation 1910. In some embodiments, the receive operation 1910 receives a text message from the organization device 310 indicating that the invitee 620 has been invited to the event. In one example embodiment, the text message includes textual information identifying the location, date, and time of the event. In another example embodiment, the text message includes a hyperlink to a web page on which information relating to the event is provided.

A reply operation 1915 transmits a response from the invitee 620 to the organization device 310. In some embodiments, the reply operation 1915 transmits a response including a participation status of the invitee 620. In one example embodiment, the reply operation 1915 transmits a “Y” if the invitee 620 plans to attend the event and an “N” if the invitee 620 plans to not attend. In other embodiments, however, other indications of participation status can be used.

In some example embodiments, the reply operation 1915 transmits a message provided by the invitee 620 along with the participation status. For example, in one embodiment, the reply operation 1915 transmits a “Y” to indicate that the invitee 620 is planning to attend and a message, such as “I'll bring the nachos,” provided by the invitee 620. The process 1900 ends at a stop module 1920.

FIG. 20 illustrates an operational flow for a process 2000 by which the organization device 310 tracks the participation status of event invitees 620. The process 2000 begins at a start module 2005 and proceeds to a receive operation 2010. The receive operation 2010 receives from the invitee 620 a response to the invitation. A determine operation 2015 reads the received response and ascertains the participation status of the invitee 620. In some embodiments, the determine operation 2015 checks whether the first character in the response is a “Y” or an “N.” In other embodiments, however, the determine operation 2015 uses other indicia to determine the participation status of each invitee 620. A store operation 2020 saves the participation status of each invitee 620 for future reference. In some embodiments, the store operation 2020 saves the participation status of each invitee 620 in a database on the organization device 310. The process 2000 ends at a stop module 2025.

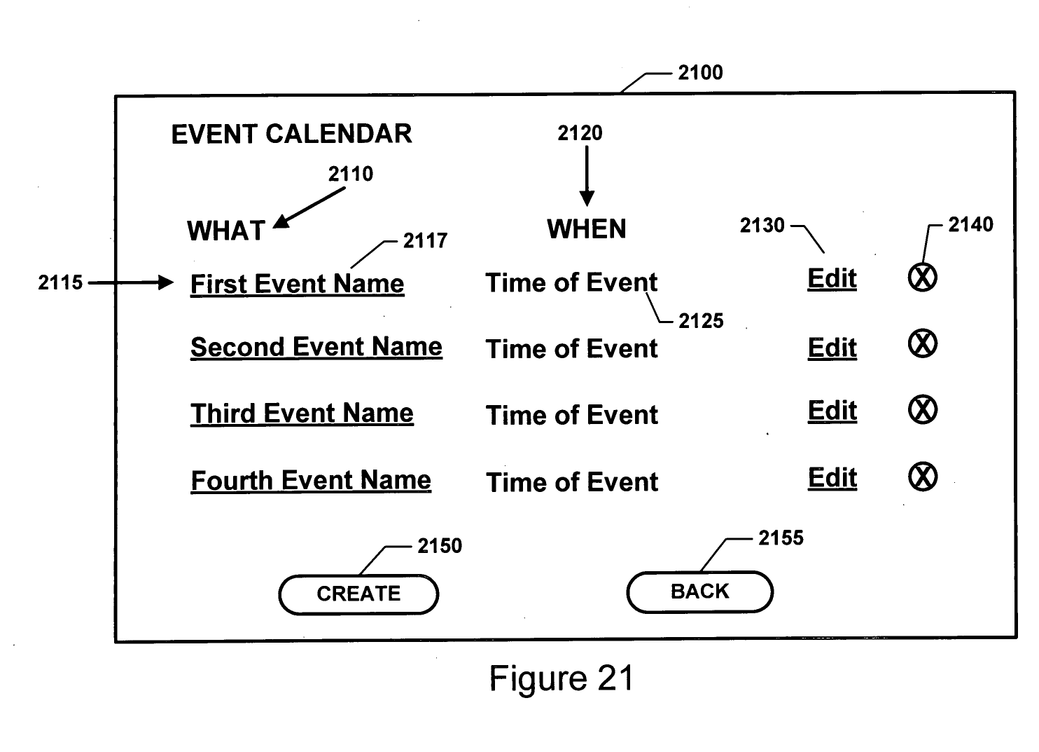

Referring now to FIGS. 21-24, an individual can view the status of each event to which the individual is a party. As the term is used herein, a party to an event is either the event organizer 610 or one of the event invitees 620. In some embodiments, for example, the individual can access a calendar interface, such as interface 2100 of FIG. 21, to obtain information about pending and recent events.

The example interface 2100 shown in FIG. 21 includes a listing 2110 of events to which the individual is a party. The entries 2115 in the listing 2110 of events provide the designation given to the event by the event organizer 610. In some example embodiments, each entry 2115 in the listing 2110 includes an interface tool 2117 enabling the individual to access additional information related to the corresponding event. In the example shown, each entry 2115 includes a hyperlink 2117 associated with a webpage containing additional information about the event.

The example interface 2100 also includes information 2120 indicating when the event is scheduled to occur. In some example embodiments, schedule information 2125 for each event indicates the date and time at which each event is scheduled to begin. In other example embodiments, however, the schedule information 2125 indicates time remaining until the event begins or time elapsed since the event occurred. In some embodiments, the interface 2100 includes navigational tools 2150, 2155 enabling an accessing individual to create a new event or return to a menu interface, respectively, such as menu interface 800 of FIG. 8.

In some example embodiments, as shown on the example interface 2100, interface tools 2130, 2140 enabling the event organizer 610 to modify or cancel, respectively, each event entry 2115 can also be provided. In one example embodiment, an edit interface tool 2130 includes a hyperlink associated with an interface configured to enable the event organizer 610 to modify the date, time, location, and other information associated with the event. In another example embodiment, a cancel interface tool 2140 includes an icon on which the event organizer 610 can click to cancel the event. In other embodiments, however, the edit and cancel interface tools 2130, 2140 are not provided.

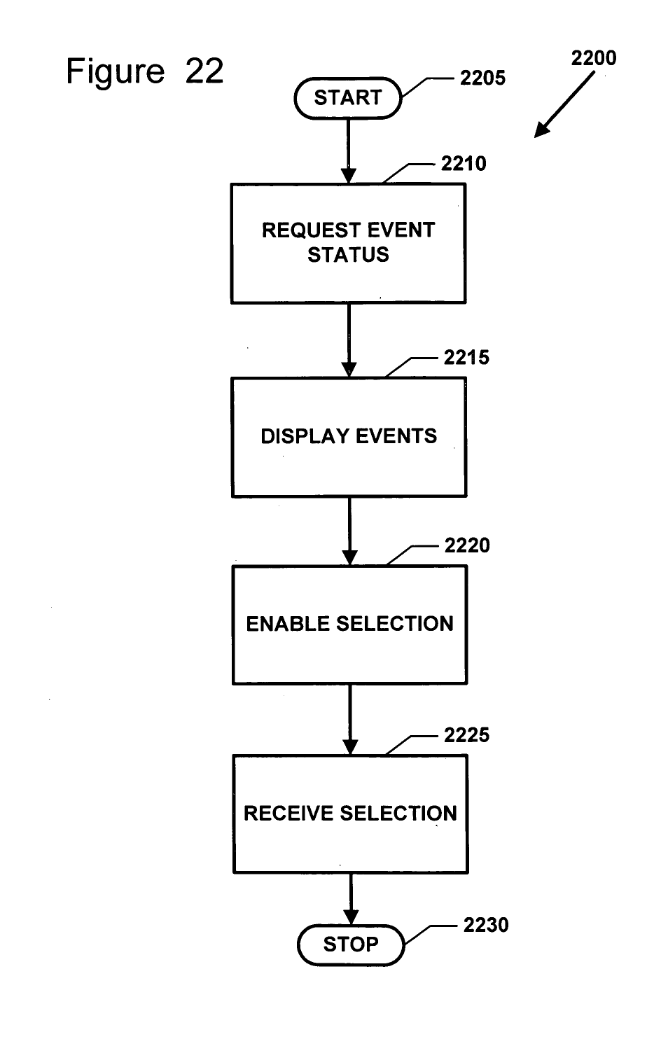

FIG. 22 illustrates an operational flow for a process 2200 for displaying event calendar information. The process 2200 begins at a start module 2205 and proceeds to a request operation 2210. The request operation 2210 receives a request from an individual to review the status of events to which the individual is a party. A display operation 2215 provides to the individual a listing of the requested events and schedule information corresponding with each event. In some embodiments, the display operation 2215 displays a calendar interface, such as calendar interface 2100 of FIG. 21.

A select operation 2220 enables the individual to trigger an action with regard to one or more of the events listed. For example, in some example embodiments, an individual can choose to obtain more information about the event, edit the event, and/or cancel the event. Each of these options will be discussed in more detail below. A receive operation 2225 receives an indication from the individual that the individual wishes to trigger an action. For example, in one embodiments, the receive operation 2225 receives a request from the individual to edit the second listed event.

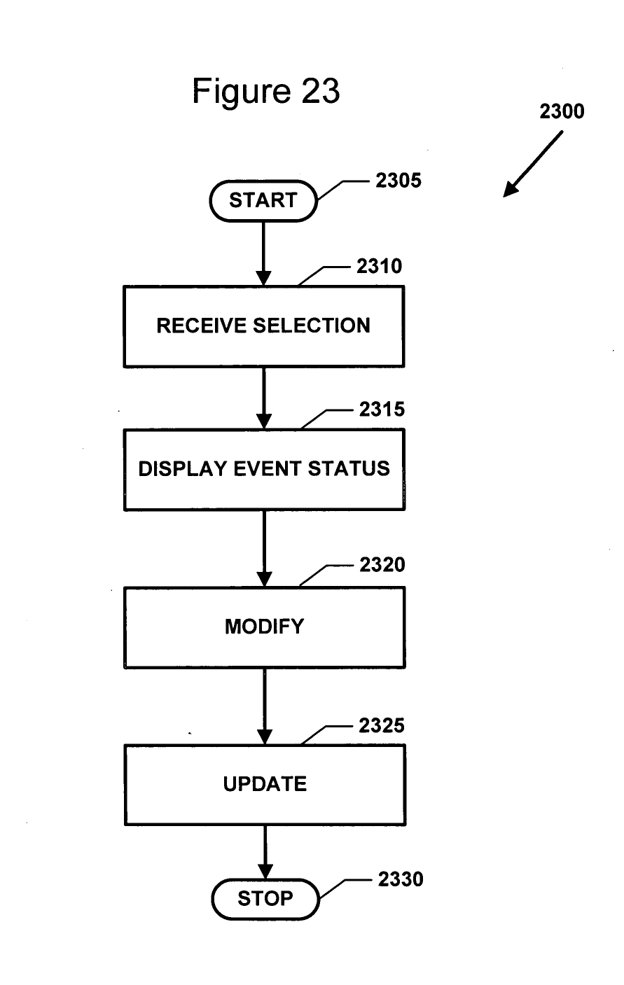

FIG. 23 illustrates an operational flow for an example process 2300 by which an event organizer 610 can edit an event. The process 2300 begins at a start module 2305 and proceeds to a receive operation 2310. The receive operation 2310 receives input from the event organizer 610 indicating that the event organizer 610 desires to edit the event. In some embodiments, the receive operation 2310 occurs when the event organizer 610 selects an interface tool, such as interface tool 2130 of FIG. 21.

A display operation 2315 provides to the event organizer 610 current information relating to the event. In some example embodiments, the current information includes the name designation of the event, the time and date on which the event is to take place, the location of the event, and a list of invitees 620. In other example embodiments, however, the display operation 2315 provides any desired information regarding the event.

A modify operation 2320 enables the event organizer 610 to change any of the information displayed in operation 2315. For example, in some embodiments, the event organizer can change the time, date, and/or location of the event. In other example embodiments, the event organizer can add and delete invitees 620 to the event. Update operation 2325 transmits a message to the invitees 620 indicating the changes to the event. The process 2300 ends at a stop module 2330.

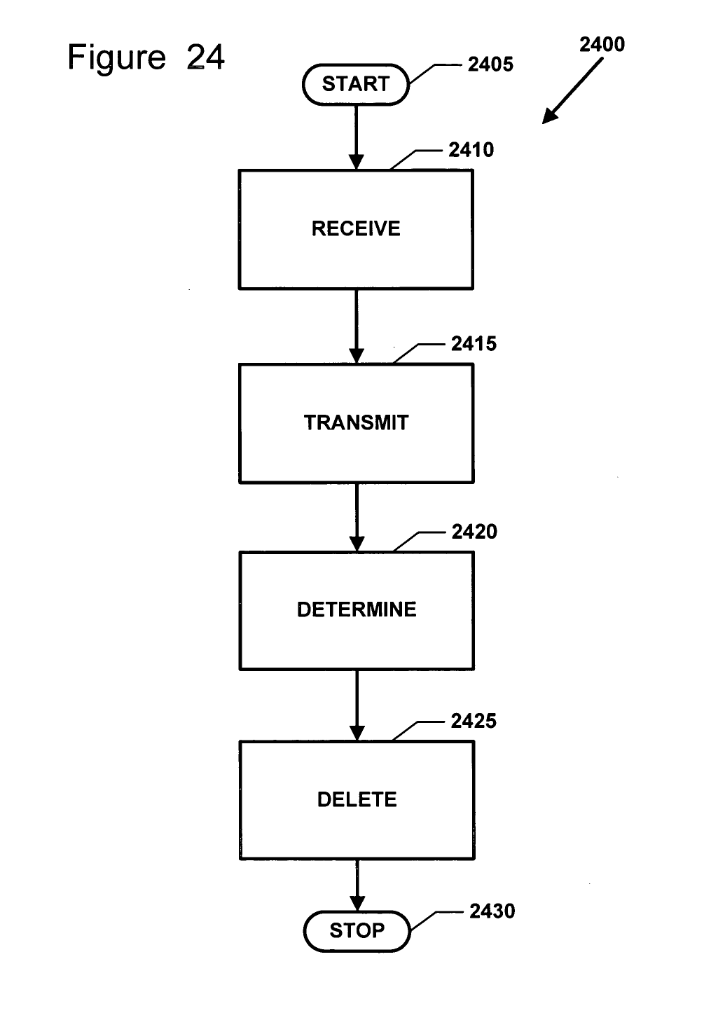

FIG. 24 illustrates an operational flow for a process 2400 by which an event organizer 610 can cancel an event. The process 2400 begins at a start module 2405 and proceeds to a receive operation 2410. The receive operation 2410 receives input from the event organizer 610 indicating that the event organizer 610 desires to cancel the event. In some embodiments, the receive operation 2410 occurs when the event organizer 610 selects an interface tool, such as interface tool 2140 of FIG. 21.

Next, a determine operation 2415 determines the contact information for each event invitee 620. In some example embodiments, contact information includes a phone number associated with the portable device 410 of each invitee 620. In other embodiments, however, any information that will enable the organization device 310 to transmit a message to the event invitees 620 can be used. A transmit operation 2420 sends a cancellation message to each event invitee 620. A delete operation 2425 removes the event from the listing of events associated with each event participant. The process 2400 ends at stop module 2430.

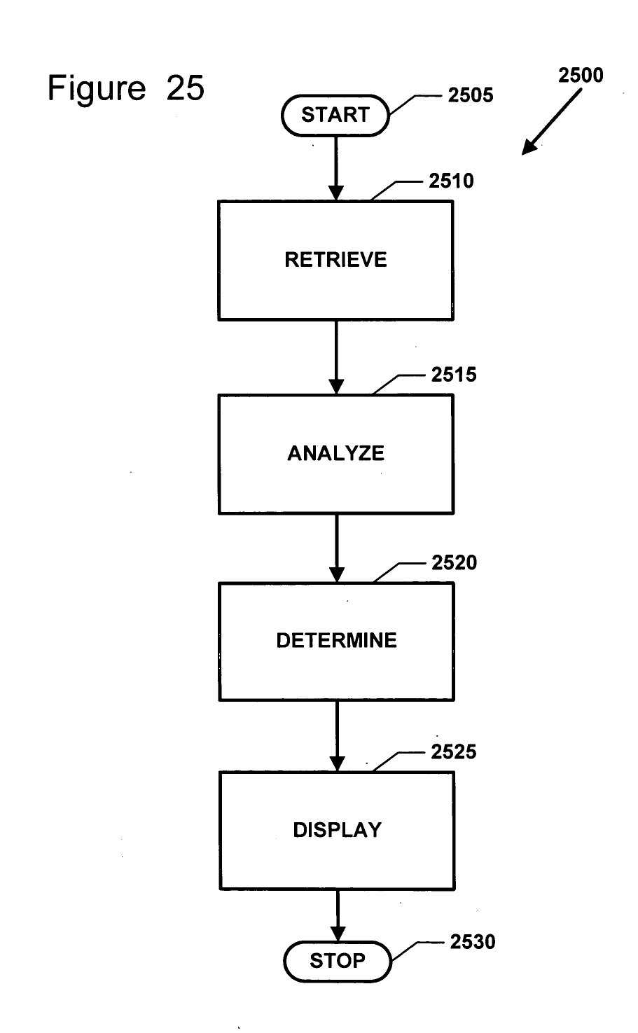

Referring now to FIGS. 25-29, an organization device, such as organization device 310 of FIG. 3, can track the attendance status of each event invitee 620. The organization device can also provide to event participants the attendance status of each invitee 620 and other information pertaining to the event. As the term is used herein, “attendance status” refers to both participation status and arrival status. Participation status is based on whether the invitee 620 indicated that the invitee 620 would be attending the event. Arrival status refers to the geographic location of an invitee 620 with respect to the event location.

FIG. 25 illustrates an operational flow for a process 2500 by which an event participant can obtain additional information pertaining to an event. The process 2500 begins at a start module 2505 and proceeds to a retrieve operation 2510. The retrieve operation 2510 obtains stored information pertaining to the event. In some embodiments, the retrieve operation 2510 accesses one or more databases on the organization device. In one example embodiment, the retrieve operation 2510 accesses an event database, such as event database 350 stored on organization device 310 of FIG. 3.

A first analyze operation 2515 determines the identity of the event invitees 620. A second analyze operation 2520 determines the participation status of each identified invitee 620. In some example embodiments, the participation status of each invitee 620 was obtained and stored by the organization device when the invitee 620 responded to the invitation sent by the organization device. In one example embodiment, the participation status of each invitee 620 is determined based on whether the first character of the response message was a “Y” or an “N.”

A display operation 2525 provides the attendance status of each invitee 620 to the individual. In some example embodiments, the display operation 2525 provides the participation status of each invitee 620. For example, in one embodiment, the display operation 2525 displays the contact name and the response (e.g., “Y” or “N”) of each invitee 620. In another embodiment, the display operation 2525 displays only the contact name of the invitees 620 who indicated they intended on attending the event.

In other example embodiments, the display operation 2525 displays an optional message provided by the invitee 620 adjacent the contact name. In one example embodiment, the displayed message communicates further information relating to the invitee's attendance at the event. For example, in such an embodiment, the display operation 2525 might display the contact name of an invitee 620 and a message from the invitee 620 indicating the invitee 620 will bring a particular item or will arrive late.

In still other example embodiments, the display operation 2525 displays arrival information. Arrival information refers to information indicating the geographic location of the invitee 620. For example, in one embodiment, if a GPS location for the invitee 620 is known, then GPS coordinates and an estimated time of arrival can be displayed. In another embodiment, the display operation 2525 can provide last known coordinates of the invitee 620 and the time at which the coordinates were obtained. In another embodiment, the display operation 2525 can show that the invitee 620 is currently at the event. The process 2500 ends at a stop module 2530.

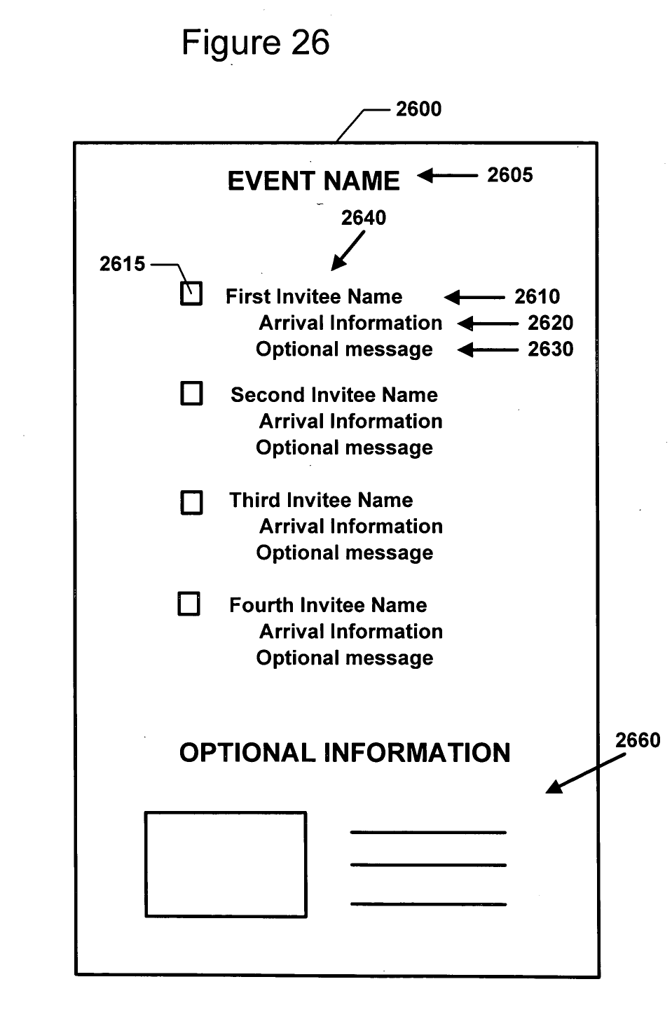

FIG. 26 depicts one example embodiment of an event status interface 2600 indicating the attendance status of invitees 620 of a particular event. The interface 2600 includes indicia 2605 designating the name of the event. The interface 2600 also includes a list 2640 of invitees 620 including a contact name 2610 and attendance information. In one example embodiment, an icon 2615 is displayed adjacent the contact name 2610.

In some example embodiments, the displayed attendance information includes arrival information 2620. In one such embodiment, the arrival information 2620 indicates the distance the invitee 620 is from the event location. In another such embodiment, the arrival information 2620 indicates an estimated time of arrival for the invitee 620. In yet another embodiment, the arrival information 2620 indicates the current location of the invitee 620. In another embodiment, the arrival information 2620 indicates the invitee 620 is at the event. In other example embodiments, the displayed attendance information includes an optional message 2630 provided by the invitee 620. In still other embodiments (not shown), the displayed information includes a participation status of the invitee 620.

In some example embodiments, the event status interface 2600 includes additional information 2660 pertaining to the event. For example, in some embodiments, the event status interface 2600 includes pictures uploaded to the organization device. In other example embodiments, the event status interface 2600 includes comments provided by event participants. Of course, any desired information can be provided to event participants on the event status interface 2600. In still other embodiments, individuals not invited to the event can view the event status interface 2600. In one such embodiment, uninvited individuals can view, but cannot upload, pictures or comments to the organization device.

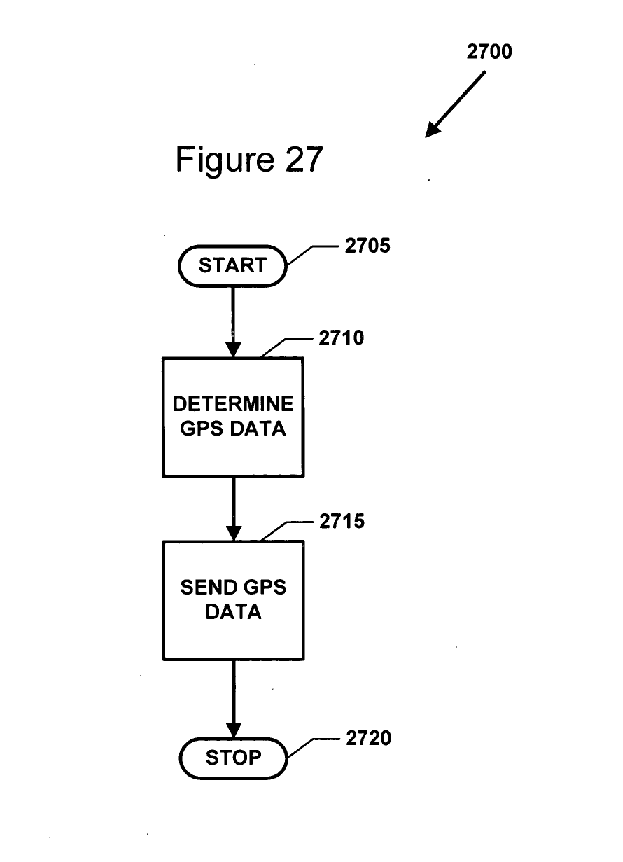

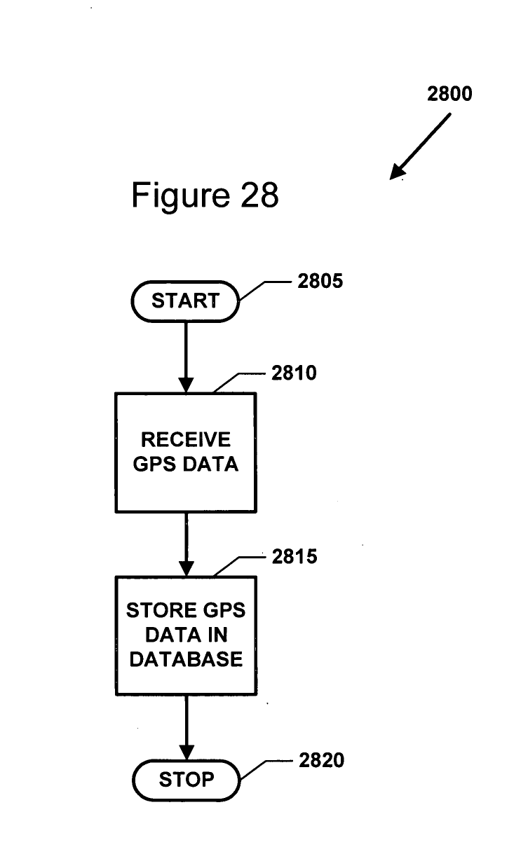

Referring to FIGS. 27-29, the organization device can track the arrival status of event participants carrying location aware portable devices, such as portable device 410 of FIG. 5. FIGS. 27 and 28 illustrate operational flows for example processes 2700, 2800 by which location information relating to an event participant is obtained. The portable device of the invitee 620 executes process 2700 and the organization device 310 executes process 2800.

The process 2700 begins at a start module 2705 and proceeds to an obtain operation 2710. The obtain operation 2710 determines the geographic location. of the portable device. In some example embodiments, the portable device includes a location determination unit, such as the location determination unit 419 of FIG. 5. In such embodiments, the portable device obtains the current location information from the location determination unit. In one example embodiment, the location determination unit includes a GPS transceiver.

In some embodiments, the location information is obtained automatically without direct interaction with the invitee 620. For example, a portable device can be configured to automatically obtain location information at predetermined time intervals. In one such example embodiment, a cellular phone 410A (FIG. 3) determines its current GPS coordinates using a built-in GPS transceiver. In other example embodiments, the location information is obtained at the direction of the invitee 620. A transmit operation 2715 sends the obtained location information to the organization device. The process 2700 ends at stop module 2720.

The process 2800 begins at a start module 2805 and proceeds to a receive operation 2810. The receive operation 2810 receives location information sent from one or more portable user devices, such as portable user devices 410 of FIG. 5. In one example embodiment, the organization device receives a data string containing GPS information indicating the location of a portable device 410 of an invitee 620. A store operation 2815 saves the location information on the organization device 310. In some example embodiments, the location information received for each invitee 620 is saved in a GPS database 360 stored on the organization device 310. The process 2800 ends at a stop module 2820.

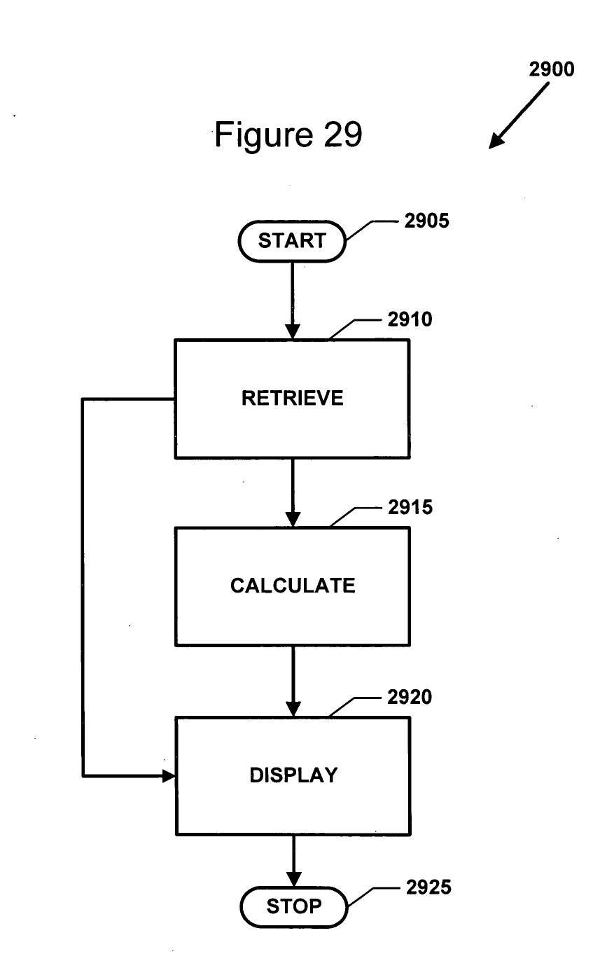

FIG. 29 illustrates an operational flow for a process 2900 by which the organization device displays arrival information for one or more event participants. The process 2900 begins at a start module 2905 and proceeds to a retrieve operation 2910. In some embodiments, the retrieve operation 2910 obtains the location information of each invitee 620. In other embodiments, the retrieve operation 2910 obtains location information for each invitee 620 and for the event organizer 610. In one example embodiment, the retrieve operation 2910 accesses a user location database, such as the GPS database 360 of FIG. 4, storing the last known GPS coordinates of each of the event participants. In other embodiments, the retrieve operation 2910 requests location information from the portable devices 410 of the event participants.

Next, in some example embodiments, the process 2900 proceeds to a display operation 2920, skipping a calculate operation 2915. In such embodiments, the display operation 2920 provides “raw” invitee location information. For example, in one embodiment, the display operation 2920 provides coordinates of latitude and longitude of the invitee 620. In other embodiments, however, the process 2900 first proceeds to a calculate operation 2915. The calculate operation 2915 calculates new information based on the information retrieved by the retrieve operation 2910. For example, in some embodiments, the calculate operation 2915 determines an estimated time of arrival based on the retrieved location information and the event location. In such embodiments, the display operation 2920 can display the estimated arrival time as well as the retrieved location information. The process 2900 ends at a stop module 2925.

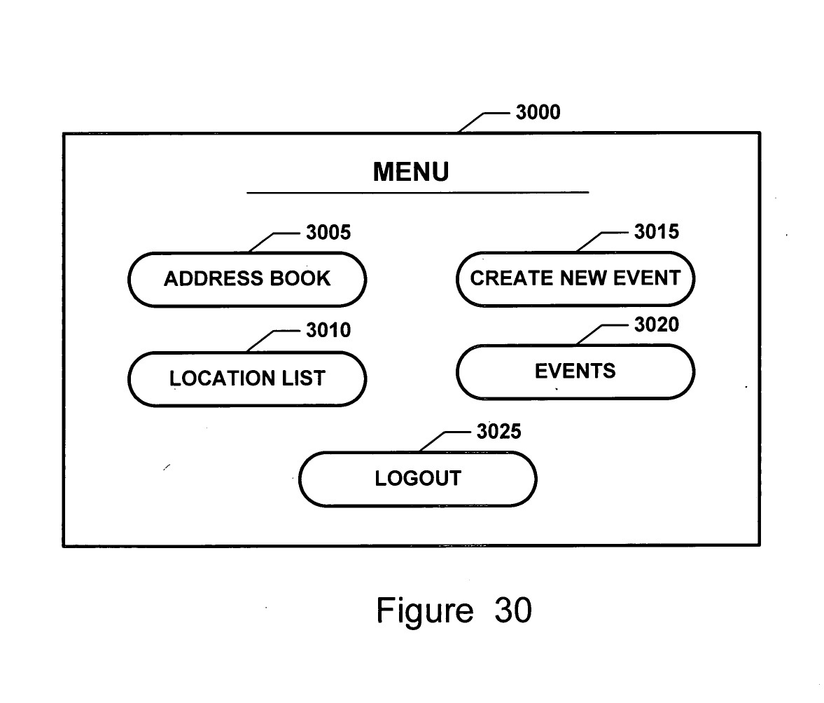

Referring now to FIGS. 30-35, the above described embodiments can best be understood through the use of an example application. In some example embodiments, the interfaces depicted in FIGS. 30-35 are adapted to be displayed on the display screen of a mobile device, such as a cellular phone 410A of FIG. 5, configured to access an organization device, such as the organization device 310 of FIG. 4. In other example embodiments, the interfaces are adapted to be displayed on the display screen of a non-mobile device. In still other embodiments, the interfaces are adapted to be displayed on a display device of the organization device, such as display device 317 of FIG. 4.

The following will walk through example interfaces viewed by an event organizer 610, Ms. Mary Planner, as she creates an event and tracks the attendance status of her guests on her cellular phone. It is assumed in the following disclosure that the cellular phone is configured to execute an application enabling the cellular phone to access an organization device. It is further assumed that the cellular phone has text messaging and WAP browsing capabilities.

FIG. 30 illustrates an example main menu interface 3000 by which Ms. Planner can access and modify various databases stored on the organization device 310. In the example shown, the main menu interface 3000 includes an “address book” button 3005, a “locations list” button 3010, a “create new event” button 3015, an “event status” button 3020, and a “logout” button 3025. By selecting the logout button 3025, Ms. Planner can exit the application, thereby terminating the connection to the organization device.

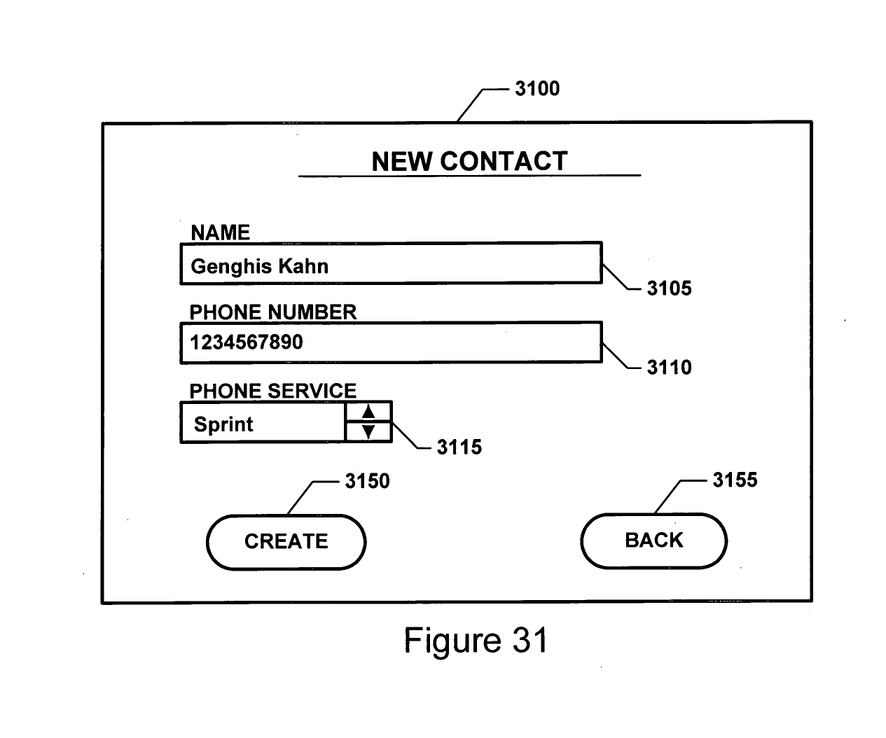

Selecting the “address book” button 3005 provides Ms. Planner with an interface through which she can add and edit the her list of contacts. For example, FIG. 31 illustrates an example interface 3100 enabling Ms. Planner to enter a new individual contact. In the example shown, Ms. Planner is adding Genghis Kahn to her address book.

The example interface 3100 shown in FIG. 31 includes a first textbox 3105 in which Ms. Planner has typed the name of the new contact (i.e., “Genghis Kahn”). The interface 3100 also includes a second text box 3110 and third text box 3115 in which Ms. Planner has typed the phone number (i.e., “123456789”) and phone service provider (i.e., “SPRINT™”) of Mr. Kahn.

The example interface 3100 also includes a create button 3150 enabling Ms. Planner to indicate that she has finished entering information and that she wishes to create a new entry in her address book. Selecting the create button 3150 saves the information entered in the textboxes 3105, 3110, 3115 to the organization device. Thereafter, Ms. Planner will be able to invite Mr. Kahn to events that she creates. The example interface 3100 also includes a back button 3155 enabling Ms. Planner to return to the main menu 3000 without adding Mr. Kahn to her address book if she so desired.

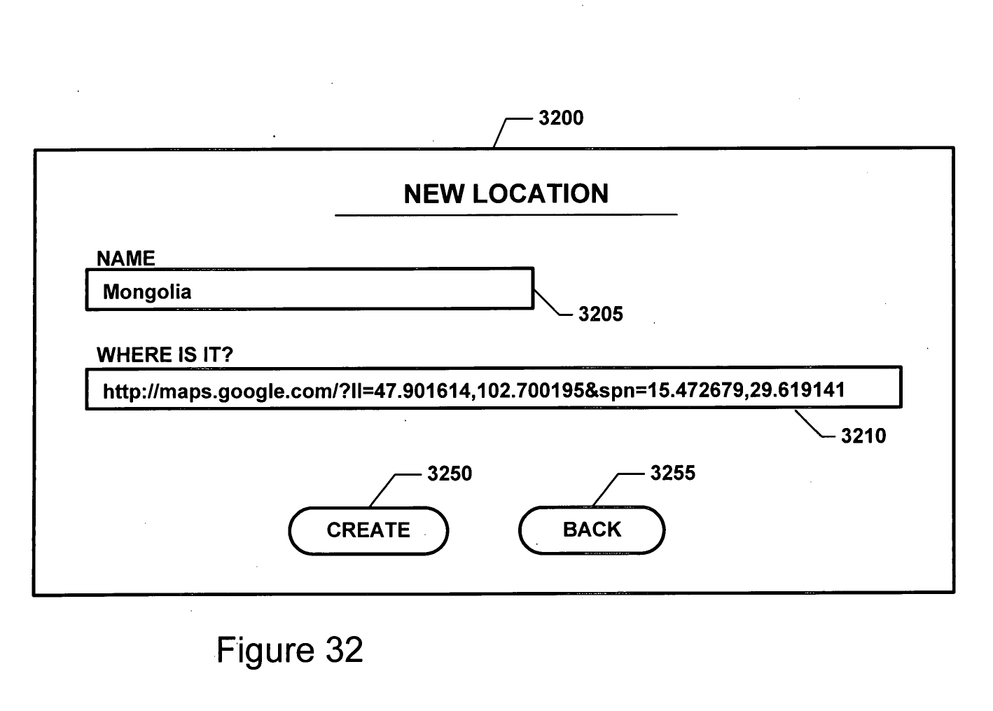

In some embodiments, selecting the “locations list” button 3010 from the main menu interface 3000 will provide Ms. Planner with an interface enabling her to add a new location to her locations list. In other embodiments, selecting the “locations list” button 3010 will provide Ms. Planner with an interface enabling Ms. Planner to edit information associated with her current locations. FIG. 32 illustrates an example interface 3200 through which Ms. Planner can enter a new location. In the example shown, Ms. Planner is adding Mongolia to her list of locations.

The example interface 3200 includes a first textbox 3205 in which Ms. Planner has typed a name designating the new location (i.e., “Mongolia”). The example interface 3200 also includes a second text box 3210 in which Ms. Planner has typed a URL (Uniform Resource Locator) address leading to a web page displaying a map indicating the geographic position of the designated location. In other embodiments, Ms. Planner could have typed in a street address associated with the named location. In still other embodiments, Ms. Planner could have typed in the name of a well-known landmark or site when more specific directions are not necessary.

The example interface 3200 also includes a create button 3250 enabling Ms. Planner to indicate that she has finished entering information and that she wishes to create a new entry in her list of locations. Selecting the create button 3250 saves the information entered in the textboxes 3205, 3210 to the organization device. Thereafter, Ms. Planner will be able to create events occurring in Mongolia. The example interface 3200 also includes a back button 3255 enabling Ms. Planner to return to the main menu 3000 without adding Mongolia to her list of locations.

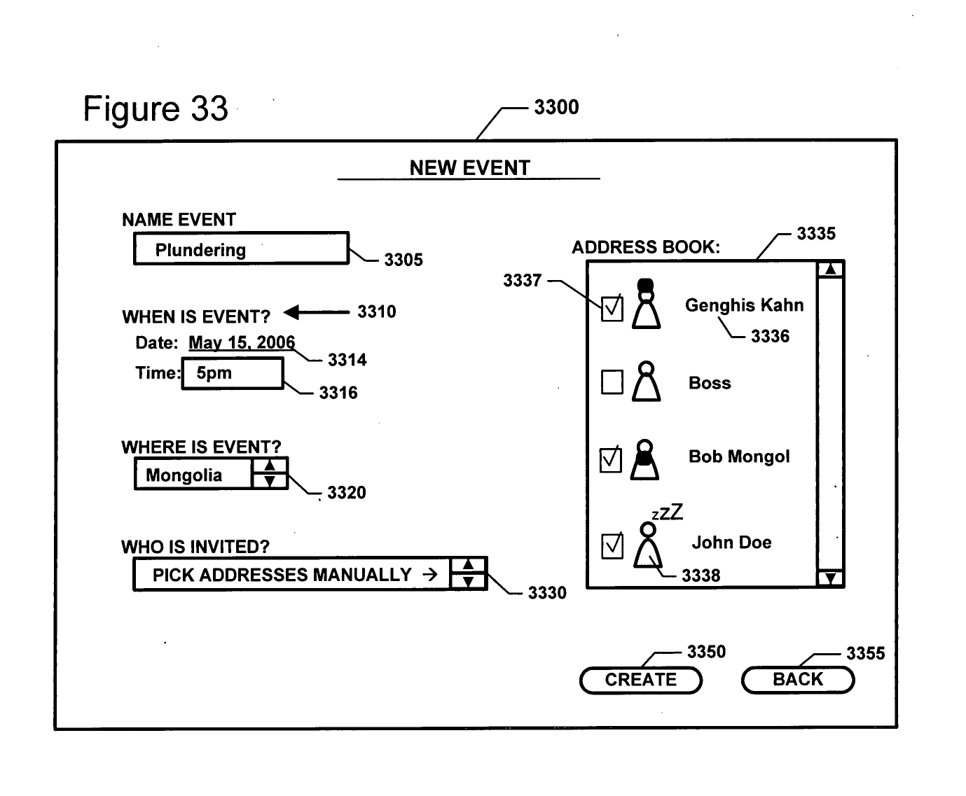

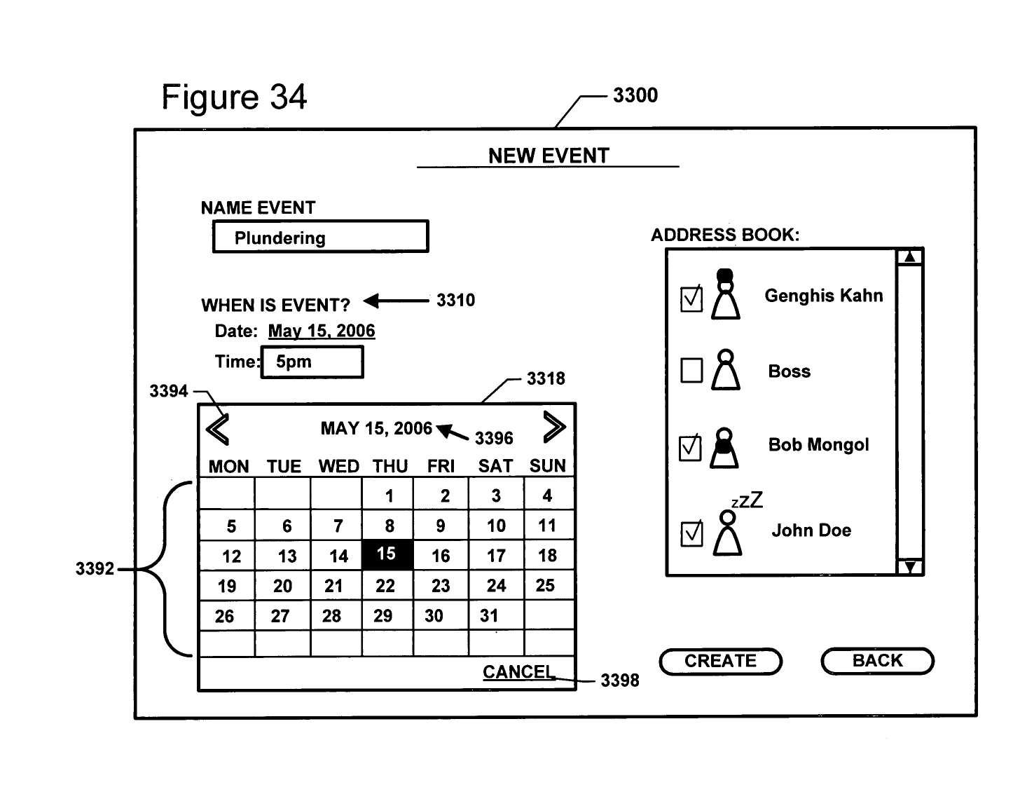

Selecting the “create new event” button 3015 from the main menu interface 3000 enables Ms. Planner to create a new event and to invite guests to her event. FIGS. 33-34 illustrate an example interface 3300 enabling Ms. Planner to create a new event. In the example shown, Ms. Planner is creating a plundering event occurring in Mongolia on May 15, 2006 at 5:00 pm. Ms. Planner has chosen to invite Genghis Kahn, Bob Mongol, and John Doe to the plundering event.

The example interface 3300 includes a first textbox 3305 in which Ms. Planner has typed the name designating the new event (i.e., “Plundering”). The example interface 3300 also includes a series of interface tools 3310 with which Ms. Planner has indicated a date and time for the event to occur. For example, Ms. Planner has scheduled the Plundering event for May 15, 2006 at 5:00 pm. In some example embodiments, the interface tools 3310 include a date interface trigger 3314 and a time interface 3316. In one example embodiment, the time interface 3316 is a textbox. In the example shown, Ms. Planner has entered her desired time, “5 pm,” into the textbox 3316.

In some example embodiments, selecting the date interface trigger 3314 causes a calendar interface 3318 to be displayed as shown in FIG. 34. The calendar interface 3318 includes a listing of dates 3392 in a calendar format. In one example embodiment, the dates are displayed by month. In such an embodiment, the calendar interface 3318 includes navigation tools, such as navigation tools 3394, to view dates corresponding to different months and years. In one embodiment, “pointing” and “clicking” on a particular date selects the date. In the example shown, Ms. Planner has indicated that she wishes to schedule the event for May 15, 2006 by selecting the “15” square in the listing 3392.

In some example embodiments, the calendar interface 3318 is superimposed over the interface 3300. In other embodiments, however, the calendar interface 3318 can be part of the interface 3300 and always visible. In one example embodiment, the currently selected date is displayed in text format as shown at 3396 in FIG. 34. In another embodiment, the calendar interface 3318 includes an interface tool 3398, such as a cancel button, that enables the event organizer 610, such as Ms. Planner, to return to the interface 3300 without selecting a date. Of course, in other embodiments, different interface tools can be used to schedule the event. For example, Ms. Planner could have used the interface tools 1820 discussed above with respect to FIG. 18.

The interface 3300 also includes a dropdown menu 3320 (FIG. 33) with which Ms. Planner can select a location from her list of locations. In the example shown, she has selected the location “Mongolia.” In some embodiments, invited contacts can also be selected from a dropdown menu, such as dropdown menu 3330. In one such embodiment, multiple contacts can be selected from the group dropdown menu 3330. By selecting one or more groups, such as “Mongol Horde,” Ms. Planner would not need to select the individual members of the group, such as Bob Mongol and Genghis Kahn. Rather, invitations would be sent to all members of the group. In the example shown, however, Ms. Planner has chosen to select addresses manually from her address book.

In some embodiments, the address book 3335 of the event organizer 610 provides a listing of the designation 3336 to all individual contacts and a corresponding selection interface 3337 for each contact. In one example embodiment, a corresponding icon 3338 is also displayed. Invitees are selected using the selection interface 3337. In the example shown, Ms. Planner has added a checkmark in the checkmark boxes 3337 corresponding to Genghis Kahn, Bob Mongol, and John Doe. Ms. Planner has chosen not to invite her boss and has not added a checkmark in his box 3337.

In other embodiments, the dropdown menu 3330 could include a listing of both groups and individuals, rather than having a separate menu 3330 and address book 3335. In still other embodiments, other interface tools could be provided from which to select event invitees 620. For example, in one example embodiment, Ms. Planner could type a name and phone number for each guest into a textbox.

The example interface 3300 also includes a create button 3350 enabling Ms. Planner to indicate that she has finished entering information and that she wishes to create a new entry in her list of events. Selecting the create button 3350 saves the information entered using interfaces 3305, 3310, 3320, 3330, and 3335 to the organization device. Thereafter, Ms. Planner will be able to track the attendance status of her guests. The example interface 3300 also includes a back button 3355 enabling Ms. Planner to return to the main menu 3000 without creating the “Plundering” event.

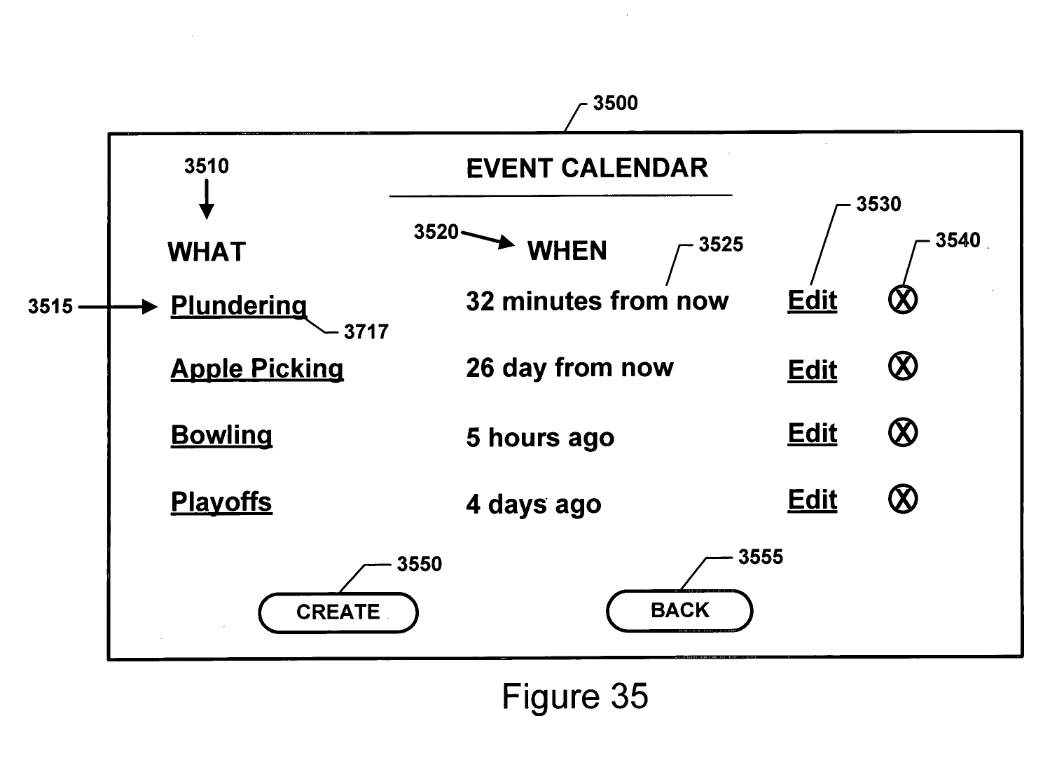

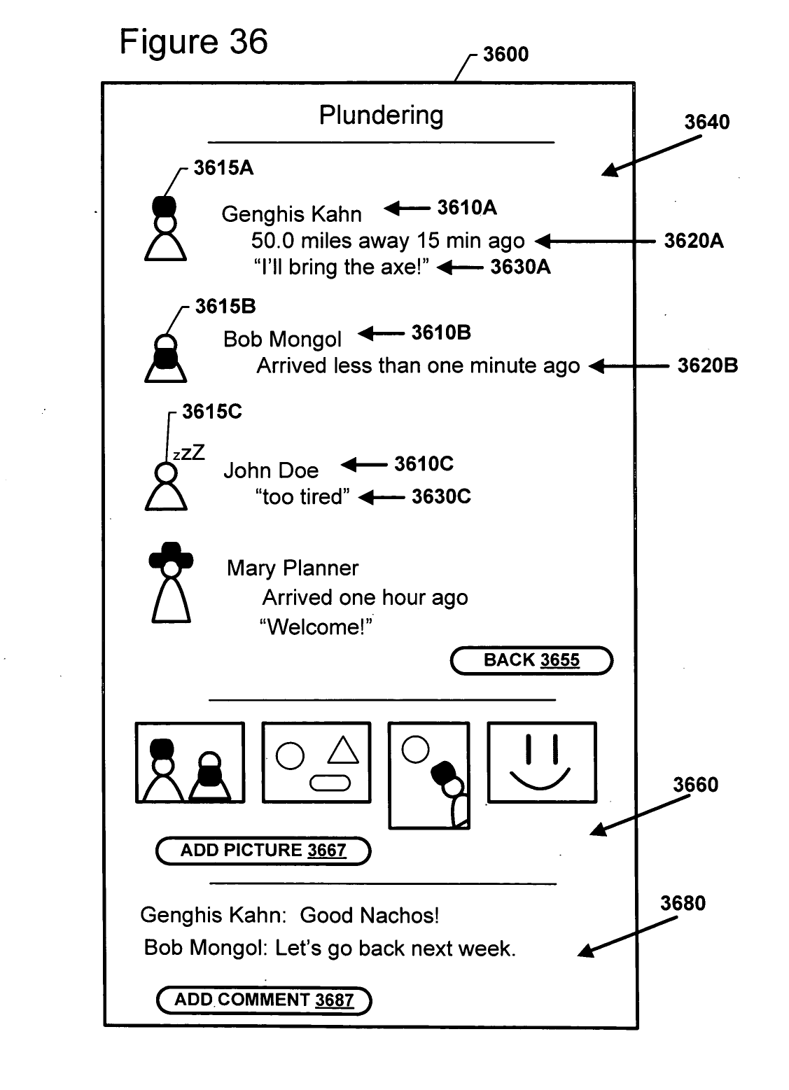

Referring now to FIGS. 35 and 36, an individual can view information pertaining to events the individual has created or to which the individual has been invited. For example, Ms. Planner can review events to which she is invited and she can monitor the attendance status of her guests for the “Plundering” event.

For example, selecting the “events” button 3020 from the main menu interface 3000 provides Ms. Planner with an interface enabling her to view pending events, including the newly created “Plundering” event. FIG. 35 depicts one example of such an interface 3500. The example events interface 3500 provides a listing 3510 of pending events. In some embodiments, recently pending events are also included in the listing 3510 on the events interface 3500.

Each entry 3515 in the listing 3510 indicates the name designating the event. For example, in the example shown, the name designating the first listed event is “Plundering” and the name designating the next listed event is “Apple Picking.” A time 3520 at which the event is scheduled to occur is also provided. In some embodiments, the time 3520 includes indicia 3525 specifying the amount of time remaining before the event occurs. In the example shown, the “Plundering” event is scheduled to occur thirty-two minutes from when the interface 3500 was accessed. The “Bowling” event, however, occurred five days before the interface 3500 was accessed.

In some embodiments, each entry 3415 in the listing 3510 also includes a corresponding interface tool 3530 with which Ms. Planner can choose to modify the event. The process for modifying an event is discussed in more detail herein with respect to FIGS. 21 and 23. Each entry 3515 also includes a corresponding interface tool 3540 with which Ms. Planner can choose to cancel the event. The process for canceling an event is discussed in more detail herein with respect to FIGS. 21 and 24.

The example interface 3500 also includes a create button 3550 enabling Ms. Planner to indicate that she has finished viewing the displayed information and that she wishes to create a new event. The process to add an event is discussed herein with respect to FIGS. 16-18, and 33. The example interface 3500 also includes a back button 3555 enabling Ms. Planner to return to the main menu 3000.

In some embodiments, each event entry 3515 in the interface 3500 includes an interface tool 3517 enabling Ms. Planner to access additional information about the event. For example, to obtain additional information about the “Plundering” event, Ms. Planner would select the hyperlinked word “Plundering” 3517. In particular, selecting the interface tool 3517 would bring her to a status interface corresponding to the “Plundering” event.

FIG. 36 depicts an example embodiment of the status interface 3600 for the “Plundering” event. The status interface 3600 includes at least a first section 3640 indicating the attendance status of invitees 620 to the plundering event. In the example shown, the first section 3640 provides the attendance status for three guests: Genghis Kahn, Bob Mongol, and John Doe. The interface 3600 also provides an interface tool 3655 enabling Ms. Planner to return to the main menu interface 3000.

In some embodiments, the interface 3600 displays a name, an icon, arrival information, and an optional message for each invitee 620. For example, in the interface 3600 shown, the first entry lists a name 3610A of “Genghis Kahn,” an icon 3615A, and arrival information 3620A indicating that Mr. Kahn was fifty miles from Mongolia fifteen minutes before the interface 3600 was accessed. A message 3630A provided by Mr. Kahn to the organization device is also displayed.

In other embodiments, however, the invitee 620 has not provided a message 3630 and/or arrival information 3620. For example, the second entry lists a name 3610B of “Bob Mongol,” an icon 3615B, and arrival information 3620B. The icon 3615B for Bob Mongol can be the same or different from the icon 3615A for Genghis Kahn. The second entry does not list a message from Mr. Mongol. The third entry in the example lists a name 3610C of “John Doe,” an icon 3615C, and a message 3630C provided by Mr. Doe. However, the third entry does not provide arrival information for Mr. Doe. In still other embodiments, participation status of each event participant can also be shown.

In some example embodiments, the event status interface 3600 includes a second section 3660 in which pictures, movies, and other such media files can be displayed. In one example embodiment, the Ms. Planner can upload a picture 3665 of the building in which the event is being held or otherwise provide to her invitees 620 graphical information pertaining to the event. In another example embodiment, event participants can upload pictures 3665 taken at the event. In another example embodiment, a map to the event could be displayed.

In the example shown, the second section 3660 includes an interface tool 3667 with which Ms. Planner or another event participant can choose to upload one or more pictures 3665 to the event status interface 3600. In some embodiments, the pictures are uploaded to and stored on the organization device. In one example embodiment, uploaded pictures are stored in the event status database 350 of the organization device 310 of FIG. 5. In other example embodiments, the event status interface 3600 enables Ms. Planner to delete pictures 3665 from the section 3660.

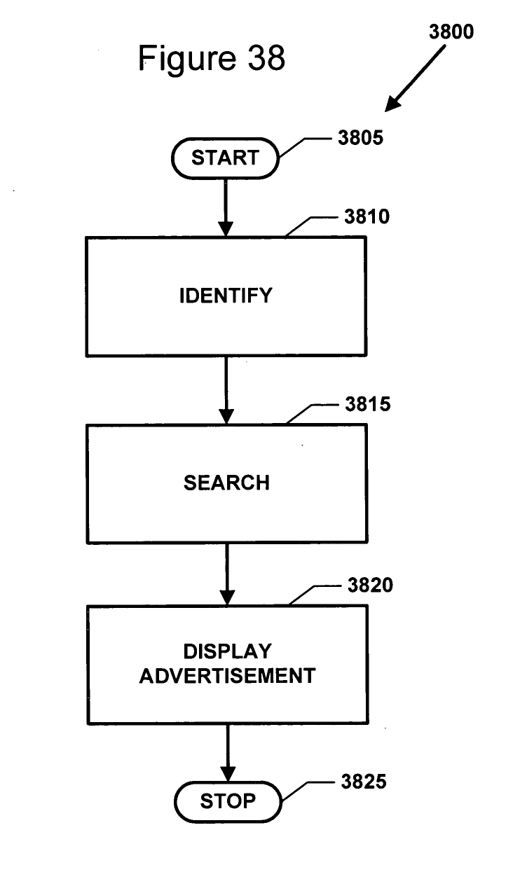

In some example embodiments, the event status interface 3800 includes a third section 3680 in which event participants can post a comment 3685 pertaining to the event. For example, in the interface 3600 shown in FIG. 38, the third section 3680 includes two comment entries 3685. Mr. Kahn has commented that he enjoyed the refreshments and Mr. Mongol has commented about his eagerness to return. In one example embodiment, the third section 3680 provides an interface tool 3687 with which event participants can add a comment entry 3685.

In other example embodiments, the event status interface 3600 is not separated into separate sections 3640, 3660, 3680. Rather, pictures 3665 and comments 3685 can be intermixed with invitee 620 attendance information.

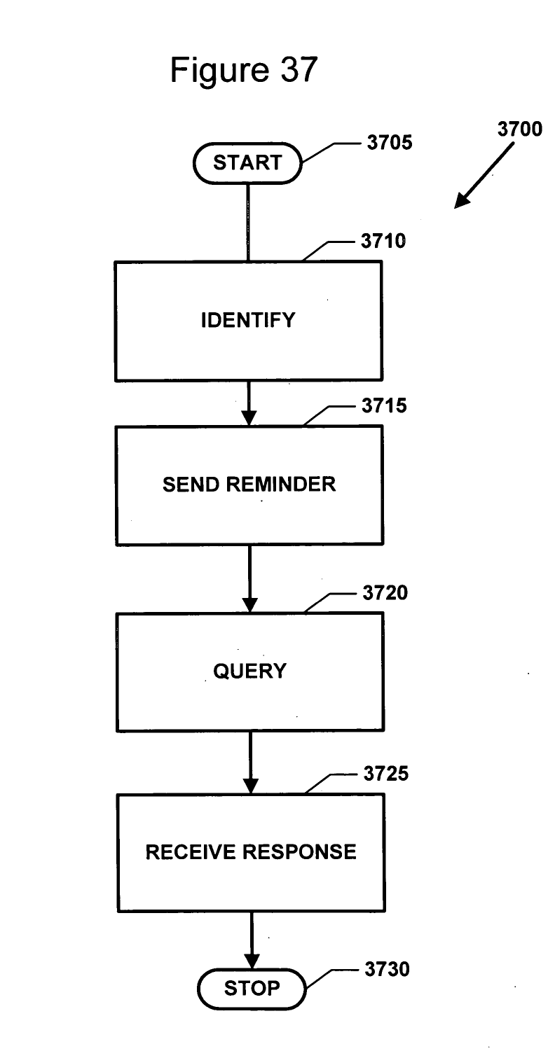

Referring now to FIGS. 37-44, some additional features are disclosed. FIG. 37 illustrates an operational flow for a process 3700 by which event reminders can be sent to invitees 620. In one example embodiment, the organization device automatically sends out event reminders to all of the invitees 620. In another example embodiment, reminders are sent only to invitees 620 who requested a reminder (i.e., “opted in”). In other embodiments, however, the event organizer 610, such as Ms. Planner, executes the process 3700 using either her user device, such as user device 210 of FIG. 5, or the organization device, such as organization device 310 of FIG. 4.

The process 3700 begins at a start module 3705 and proceeds to an identify operation 3710. The identify operation 3710 determines which contacts were invited to an event and obtains the contact information for each invitee 620. In some example embodiments, the identify operation 3710 determines which invitees 620 opted in for receiving an event reminder.

A transmit operation 3715 sends reminders to the invitees 620. In some embodiments, the reminders are text messages sent to the user devices 210 of the invitees 620. In other embodiments, the reminders are WAP Push messages that direct the invitees 620 to a WAP page containing reminder information. In still other embodiments, the reminders are sent via email to the invitees 620.

In some embodiments, from the transmit operation 3715, the process 3700 proceeds to a stop module 3730. In other embodiments, however, the process 3700 proceeds to a query operation 3720. The query operation 3720 enables the invitees 620 to provide or update their participation status. For example, if an invitee 620 previously responded to the event invitation by indicating he would attend, and if the invitee 620 later realized that the event occurred during his anniversary, then he could update his participation status to reflect that he would not be attending the event. Alternatively, in another example embodiment, the same invitee 620 could provide a message indicating that he would be bringing another person to the event.

A receive operation 3725 receives information sent from the invitee 620 in response to the reminder. In some embodiments, the receive operation 3725 receives an updated participation and/or an updated message. In such an embodiment, the participation status and/or message are added to the event status interface, such as event status interface 3600 of FIG. 36. The process 3700 ends at a stop module 3730.

FIG. 38 illustrates an operational flow for a process 3800 with which the organization device, such as organization device 310 of FIG. 4, can provide targeted advertisements to event participants. The process 3800 begins at a start module 3805 and proceeds to an identify operation 3810. The identify operation 3810 determines the geographic location of the event.

A search operation 3815 determines whether one or more advertisements available to the organization device correspond with the geographic location of the event. In some embodiments, the advertisements are stored in a database (not shown) or other storage device on the organization device. In other embodiments, the advertisements are stored on a server, such as server 240 of FIG. 3, communicatively coupled to the organization device 310. In such embodiments, the search operation 3815 can search an advertisement index stored on the organization device 310 or can request the desired information from the server.

A display operation 3820 transmits any advertisements found by the search operation 3815 to the user device 210 of the invitees 620. For example, when an invitee 620 accesses an event status WAP page, such as event status interface 3800, on her cellular phone 410 for an event occurring at the Mall of America in Bloomington, Minnesota, then the invitee 620 may view advertisements for stores and restaurants located in the Mall of America. Processes for obtaining and displaying targeted advertisements on a web browser are well known in the art. The process 3800 ends at stop module 3825.

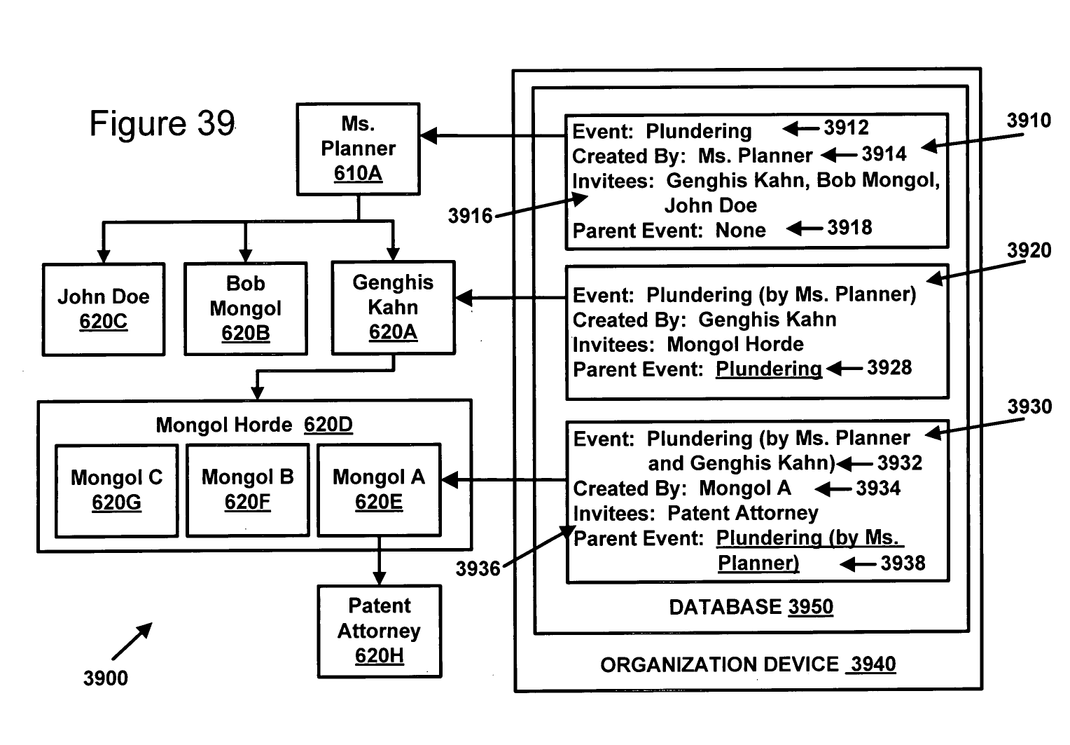

FIGS. 39-44 illustrate one example of an event forwarding feature that enables an invitee to invite additional people to an event. In some embodiments, the second and later generation invitees send responses to the invitation to the organization device, such as organization device 3940 of FIG. 39. In one such embodiment, the organization device tracks the attendance status of the second and later generation invitees as well as the first generation invitees. In some embodiments, the organization device also tracks the invitation chain for the event. Tracking the invitation chain enables the sequence of event invitations to be traced forwards or backwards from any invitee.

For example, FIG. 39 is a block diagram depicting an invitation chain beginning with Ms. Planner 610A and ending with Mongol B 620F, Mongol C 620G, and Patent Attorney 620H. According to FIG. 39, the first generation of invitees, which were invited by Ms. Planner 61 OA, includes Genghis Kahn 620A, Bob Mongol 620B, and John Doe 620C. Mr. Kahn 620A, after receiving his invitation, forwarded the invitation on to his Mongol Horde contacts 620D. Individuals Mongol A 620E, Mongol B 620F, and Mongol C 620G are associated with the Mongol Horde group 620D. Mongol A 620E has chosen to forward his invitation on to Patent Attorney 620H.

In some embodiments, an organization device, such as organization device 3940, tracks the invitation chain by creating a new event each time an event invitation is forwarded. In one such embodiment, as shown in FIG. 39, each new event is saved in an event record in an event database, such as event database 3950 on organization device 3940. For example, when Ms. Planner 610A first creates the event, she creates a first record 3910 in the event database 3950. In the example embodiment shown, the first record 3910 identifies an event designation 3912 (i.e., “Plundering”), an event organizer 3914 (i.e., “Ms. Planner”), a list 3916 of invitees 620 (i.e., first generation invitees), and a parent event 3918, if any.

When Genghis Kahn decides to forward the “Plundering” event invitation to his Mongol Horde group contact, the organization device 3940 creates a second event record 3920 in the event database 3950. In the embodiment shown, the new event record 3920 lists the event designation 3922 as “Plundering (by Ms. Planner)” and Mr. Kahn is listed as the event organizer at 3924. In other embodiments, however, Mr. Kahn can modify the event designation 3922. In some embodiments, the second record also includes a link 3928 to the parent event record 3910. The link 3928 enables the organization device 3940 to trace the newly created “Plundering (by Ms. Planner)” event to the original “Plundering” event.

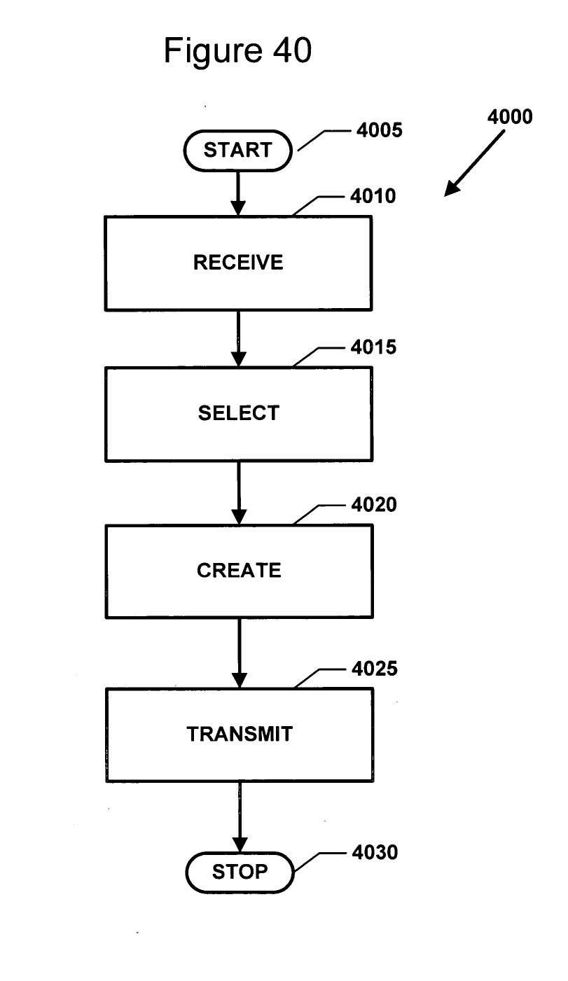

FIG. 40 provides an operation flow for a process 4000 by which an invitee 620 to an event can forward his invitation to one or more additional invitees. The process 4000 begins at start module 4005 and proceeds to receive operation 4010. The receive operation 4010 obtains an invitation to an event. For example, as discussed above, Mongol A 620E of FIG. 39 receives an invitation from Mr. Kahn. Next, select operation 4015 enables Mongol A to choose whether or not to forward the event to one or more of Mongol A's contacts.

A create event 4020 enables Mongol A 620E to access the organization device 3940 to create a new event. In some embodiments, the create event 4020 operation enables Mongol A 620E to add a new event record, such as event record 3930, to an event record database, such as event record database 3950. In the example shown in FIG. 39, event record 3930 lists the event designation 3932 as “Plundering (by Ms. Planner and Genghis Kahn”) and the event organizer 3934 as Mongol A 620E. The event record 3930 also includes a link 3938 to the parent event, “Plundering (by Ms. Planner),” which was created by Genghis Kahn. Mongol A 620E has chosen to invitee Patent Attorney 620H to the event. Transmit operation 4025 sends the invitation to the new event (i.e., “Plundering (by Ms. Planner and Genghis Kahn)”) to Patent Attorney 620H. The process ends at stop module 4030.

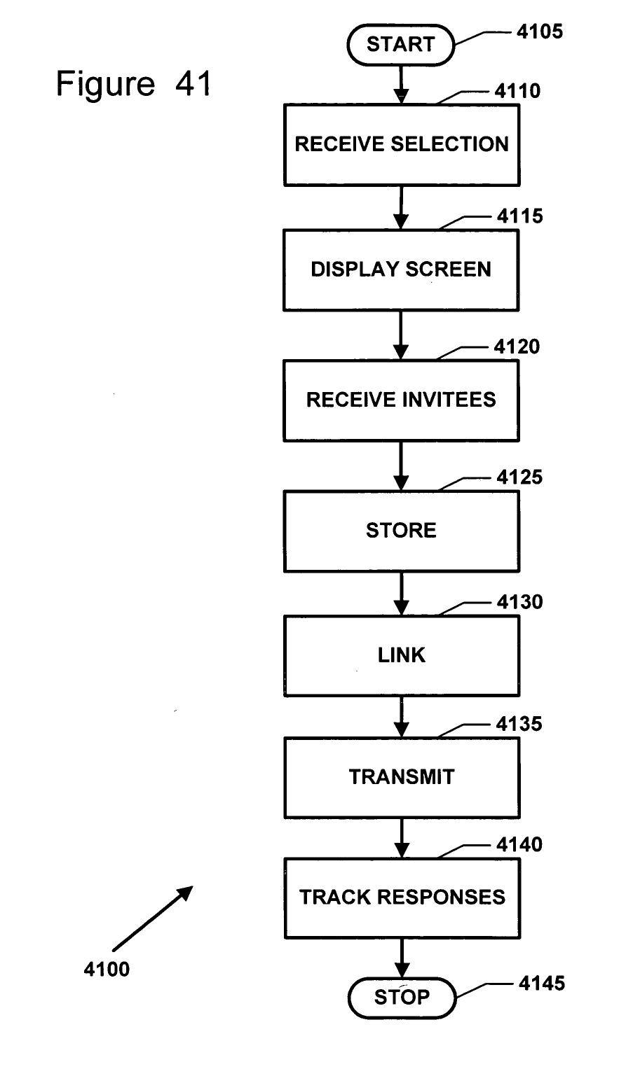

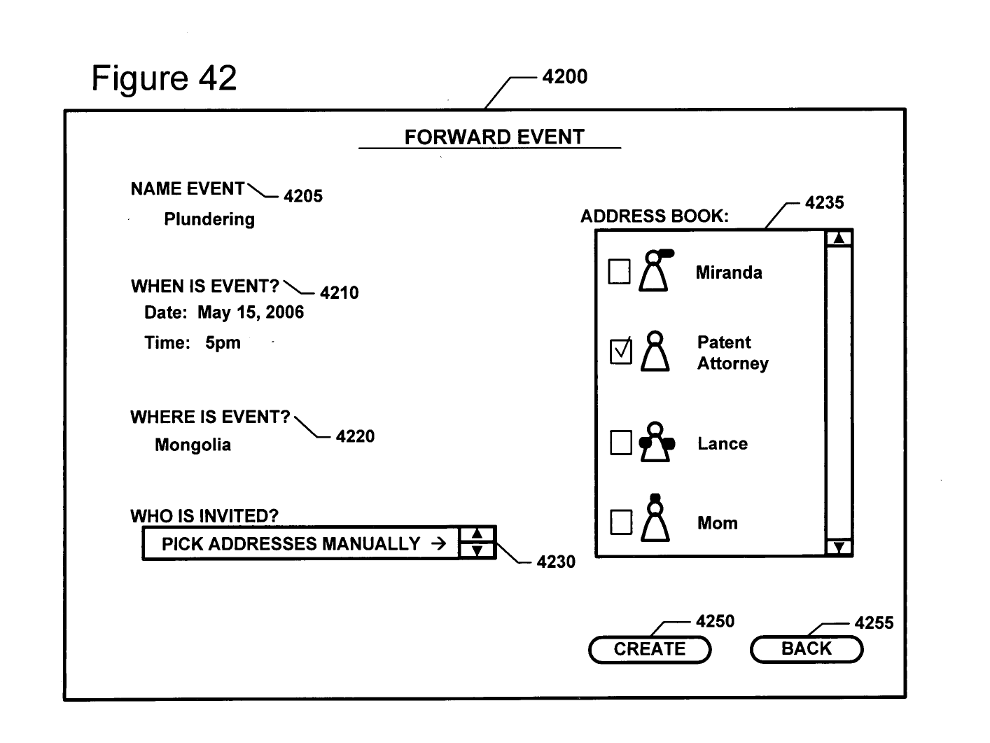

FIG. 41 illustrates an operation flow for a process 4100 by which the organization device, such as organization device 3940 of FIG. 39, can track the invitation chain for each event. The process 4100 begins at start module 4105 and proceeds to a first receive operation 4110, which receives a request from an event invitee (hereafter referred to as an “event forwarder”) to forward an event. A display operation 4115 displays an event forwarding interface, such as interface 4200 of FIG. 42, to the second event organizer. A second receive operation 4120 obtains a list of additional invitees to whom the event forwarder wishes to forward the event invitation.

Store operation 4125 saves relevant information on the organization device. In some embodiments, store operation 4125 creates a new event record, such as record 3930, and saves the record 3930 on an event database, such as database 3950 of FIG. 39. In one such embodiment, the store operation 4125 stores the designation of the event, the event organizer (i.e., the event forwarder), and the identity of each additional invitee in the event record 3930. Link operation 4130 creates a link in the database record to the parent database record. For example, link operation 4130 creates a link 3938 in record 3930 to the event record 3920 of the parent event (i.e., “Plundering (by Ms. Planner)).” Through this link 3938, the organization device can trace the creation and invitation chain of the forwarded event.

Transmit operation 4135 sends invitations to the newly created event to the additional invitees selected by the event forwarder (e.g., Mongol A 620E). In the example shown in FIG. 39, the transmit operation 4135 sends an invitation to “Plundering (by Ms. Planner and Genghis Kahn)” to Patent Attorney 620H. Track operation 4140 receives and saves any response sent from the additional invitees regarding the attendance status of the additional invitees. The process ends at stop module 4145.

FIG. 42 illustrates one example of an event forwarding interface 4200 displayed by the display operation 4115 of process 4100. The interface 4200 includes a listing of the event designation 4205, the event schedule 4210, and the event location 4220. In the example shown in FIG. 42, the event forwarding interface 4200 only enables selection of additional invitees and does not enable modification of the other event information. In other examples, however, the event forwarding interface 4200 can enable modification of the event designation, event schedule, and/or event location.

In some embodiments, the event forwarder selects additional invitees using an interface tool 4230. In one example embodiment, the interface tool 4230 includes a dropdown menu listing groups created by the event forwarder. In other embodiments, however, the event forwarding interface 4200 also provides access to the event forwarder's address book 4235 similar to the create event interface 3300 of FIG. 33.

In some embodiments, the example interface 4200 also includes a create button 4250 enabling the event forwarder to indicate that he has finished entering information and that he wishes to transmit the event invitations to the additional invitees. In one example embodiment, selecting the create button 4250 saves the information entered using interfaces 4230, 4235 to the organization device and transmits the invitations to the selected invitees. The example interface 4200 also includes a back button 4255 enabling the event forwarder to return to the main menu 3000 without forwarding the event.

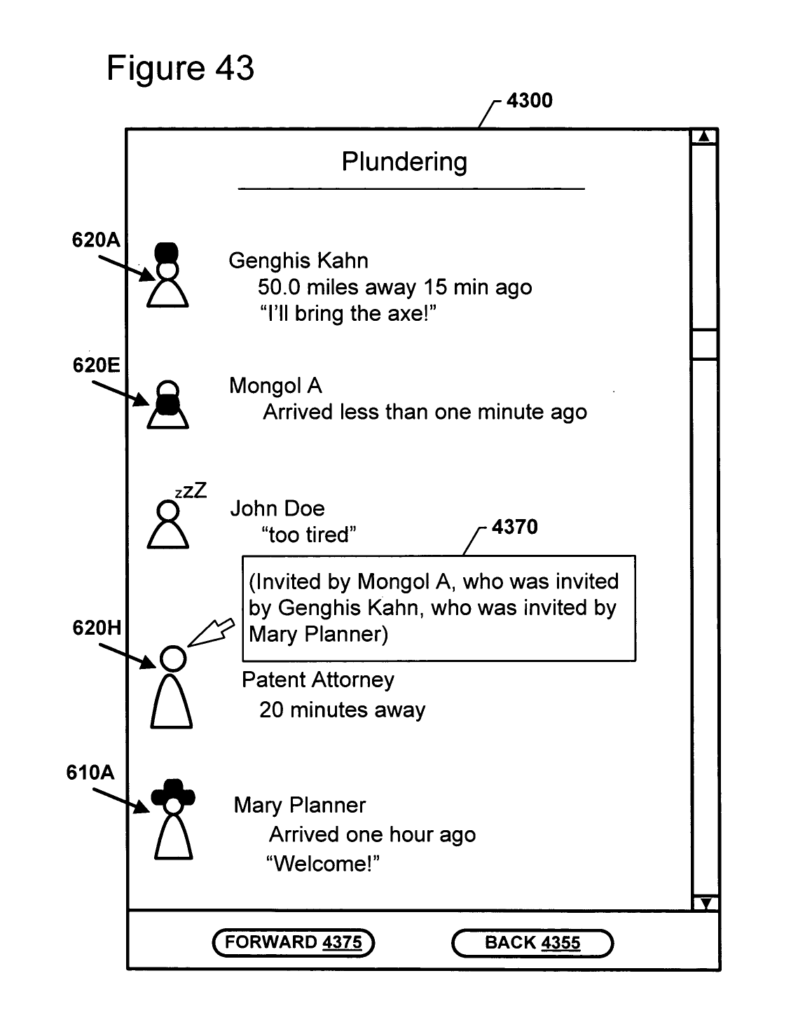

FIG. 43 illustrates another example event status interface 4300 similar to the event status interface 3600 of FIG. 36. As in the event status interface 3600, the event status interface 4300 provides the attendance status of event participants 610, 620. In addition, however, the event status interface 4300 can provide additional information about the event participants 610, 620.

In some embodiments, selecting one of the displayed event participants 610, 620 provides additional information about the participant. For example, in one embodiment, selecting an event participant displays a pop-up box 4370 providing the invitation chain for the selected event participant. In the example shown, Patent Attorney 620H has been selected. Pop-up box 4370 indicates that Patent Attorney 620H was invited by Mongol A 620E, that Mongol A 620E was invited by Genghis Kahn 620A, and that Genghis Kahn 620A was invited by Mary Planner 610A. In other embodiments, however, any desired information can be provided for the selected event participant.

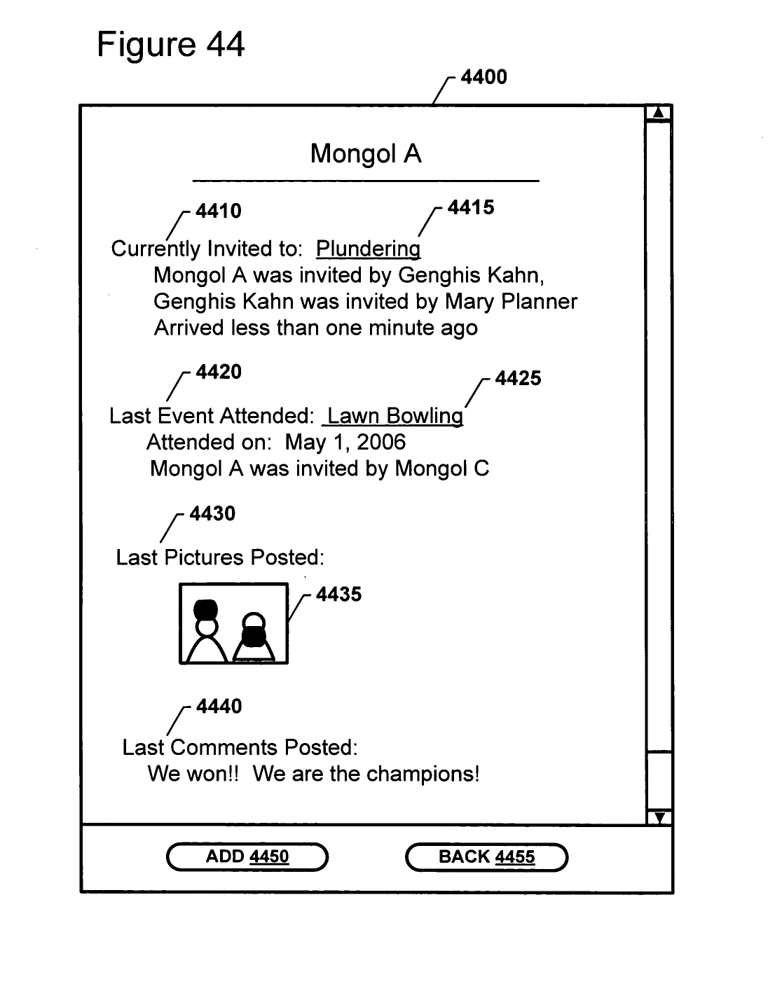

In still other embodiments, information pertaining to a selected event participant can be displayed on an invitee information interface, such as the example invitee information interface 4400 shown in FIG. 44. In general, an invitee information interface 4400 provides information about a selected invitee 620.

In some embodiments, the information interface 4400 provides information related to the current event. For example, in the embodiment shown, the example interface 4400 provides arrival information and invitation chain information for Mongol A at 4410. The example interface 4400 also provides a link 4415 to the event status page of the current event. In other example embodiments, however, any desired information can be displayed.

In some embodiments, for example, the interface 4400 provides information on the last event(s) attended by the selected event participant. For example, the interface 4400 provides the designation, date, and invitation chain of the last event attended by Mongol A. In other example embodiments, the location of the event or other desired information is also shown. In still other example embodiments, the interface 4400 provides a link 4425 to the event status page of the previous event.

In some example embodiments, the example interface 4400 displays recent pictures/movies posted by the selected event participant. For example, the example interface 4400 includes at 4430a picture 4435 posted by Mongol A. In one such example embodiment, an event designation or a posting date pertaining to the picture is also provided at 4430. In other example embodiments, the example interface 4400 also displays recent comments posted by Mongol A, such as the comment “We won!! We are the champions!” at 4440.

The example interface 4400 also includes an add button 4450 enabling a selector to add the selected event participant to her address book. In some embodiments, selecting the add button 4450 automatically saves contact information for the selected event participant to the address book of the selector. In other embodiments, however, selecting the add button 4450 displays a new contact interface, such as new contact interface 3100 of FIG. 31, enabling the selector to manually enter at least some of the contact information of the selected event participant. Thereafter, the selector will be able to invite the selected event participant to events she creates. The example interface 4400 also includes a back button 4455 enabling the selector to return to the main menu, such as menu 3000 of FIG. 30.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A method comprising:
scheduling an event occurring at a location;
inviting event participants to the location-specific event;
tracking an attendance status of each event participant; and
providing the attendance status of each event participant to a requesting event participant;
wherein the attendance status of at least one event participant includes a geographic position of the event participant in relation to the location.

2. The method of claim 1, further comprising receiving a response from the event participants, the response including an indication of participation status.

3. The method of claim 2, wherein the response includes a message provided by the event participant.

4. The method of claim 2, wherein the response includes a request for a reminder message.

5. The method of claim I, further comprising sending reminders to the event participants.

6. The method of claim 1, further comprising:
receiving pictures uploaded by event participants;
providing the uploaded pictures to the requesting event participant;
receiving comments uploaded by event participants; and
providing the uploaded comments to the requesting event participant.

7. The method of claim 1, wherein scheduling an event includes selecting a date and time for the event.

8. The method of claim 1, wherein inviting event participants includes selecting contacts from an address book.

9. The method of claim 1, wherein scheduling an event includes selecting a location from a list of locations.

10. The method of claim 1, further comprising:
receiving a request to forward an event from one of the invited event participants;
receiving a selection of at least one additional event participant;
transmitting an event invitation to the additional event participant;
tracking an attendance status of each additional event participant; and
providing the attendance status of each additional event participant to the requesting event participant.

11. A system comprising:
an organization device configured to enable an event organizer to schedule an event occurring at a location, the organization device further configured to transmit invitations to the event; and
a plurality of user devices configured to receive the transmitted invitations and to send responses to the organization device, at least one of the plurality of user devices configured to determine a current location of the at least one device and to transmit the current location to the organization device.

12. The system of claim 11, wherein the at least one user device is a cellular phone configured to receive text message.

13. The system of claim 11, wherein the at least one user device includes a GPS transceiver.

14. The system of claim 11, wherein the organization device is configured to provide the current location of the at least one device so as to be accessible to the plurality of user devices.

15. The system of claim 14, wherein the organization device provides the current location of the at least one device on a web page.

16. The system of claim 11, wherein the organization device stores an address book associated with at least one user.

17. The system of claim 11, wherein the organization device stores pictures pertaining to an event scheduled on the organization device.

18. The system of claim 11, wherein the organization device transmits the invitation as a text message.

19. A method comprising:
scheduling an event occurring at a location including selecting the location and selecting a date and time at which the event will occur;
inviting event participants to the event including selecting at least some of the event participants from an address book;
enabling event participants to invite additional event participants;
tracking which event participants invited which additional event participants;
receiving replies from the event participants and the additional event participants including receiving a participation status of the event participants and the additional event participants;
receiving a request from a requesting event participant to view the participation status of the event participants and the additional event participants;
providing to the requesting event participant the participation status of the event participants and the additional event participants;
receiving an arrival status from at least one of the event participants or the additional event participants, the arrival status including GPS coordinates corresponding to a location of the at least one event participant or additional event participant;
calculating an estimated time at which the at least one event participant or additional event participant will arrive at the location of the event; and
providing to the requesting event participant the estimated time at which the at least one event participant or additional event participant will arrive at the location of the event.

20. The method of claim 19, further comprising:
enabling event participants to submit pictures pertaining to the event;
associating pictures submitted by the event participants with the corresponding event participants;
enabling event participants to submit comments pertaining to the event;
associating comments received from the event participant with the corresponding event participants;
associating events created by event participants with the corresponding event participants;
associating events to which each of the event participants is invited with the corresponding event participants; and
providing to a second requesting event participant a listing of events created by a selected one of the event participants, a listing of events to which the selected one of the event participants is invited, the pictures associated with the selected one of the event participants, and the comments associated with the selected one of the event participants.
